(19) United States
(12) Patent Application Publication
(10) Pub. No.: US 2026/0051967 A1
(43) Pub. Date: Feb. 19, 2026

(54) SIGNALING SUPPORT FOR MULTIPLE CODING SCHEMES TO A SINGLE USER DEVICE SPANNING A FREQUENCY DOMAIN

(71) Applicant: QUALCOMM Incorporated, San Diego, CA (US)

(72) Inventors: Jialing Li CHEN, San Diego, CA (US); Lin YANG, San Diego, CA (US); Bin TIAN, San Diego, CA (US); Sameer VERMANI, San Diego, CA (US)

(21) Appl. No.: 18/805,192

(22) Filed: Aug. 14, 2024

(51) Int. Cl. H04L 1/00

(52) U.S. Cl. CPC H04L 1/0003; H04L 1/0026; H04L 1/0068

(57) ABSTRACT

This disclosure provides methods, components, devices and systems for signaling support for multiple coding schemes to a single user device spanning a frequency domain. A first wireless device may identify respective quality information associated a set of resource units (RUs) that span a frequency bandwidth. The first wireless device may transmit information signaling that indicates a first modulation and coding scheme (MCS) or a first modulation pattern to be applied to a first RU and a second MCS or a second modulation pattern to be applied to a second RU. The first wireless device may communicate first bits of a first service data unit via the first RU using the first MCS or the first modulation pattern, and second bits, of the first service data unit or of a second service data unit, via the second RU using the second MCS or the second modulation pattern.

### TECHNICAL FIELD

This disclosure relates generally to wireless communication and, more specifically, to signaling support for multiple coding schemes to a single user device spanning a frequency domain.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method for wireless communications by a first wireless device is described. The method may include identifying respective quality information associated with each resource unit (RU) of a set of multiple RUs that span a frequency bandwidth, transmitting, in accordance with the respective quality information, information signaling that indicates a first modulation and coding scheme (MCS), a first modulation pattern, or both, to be applied to a first RU of the set of multiple RUs and a second MCS, a second modulation pattern, or both, to be applied to a second RU, where the first MCS differs from the second MCS, and where the first modulation pattern differs from the second modulation pattern, communicating, in accordance with the information signaling, one or more first bits of a first service data unit via the first RU using the first MCS, the first modulation pattern, or both, and communicating, in accordance with the information signaling, one or more second bits, of the first service data unit or of a second service data unit, via the second RU using the second MCS, the second modulation pattern, or both.

A first wireless device for wireless communications is described. The first wireless device may include a processing system that includes processor circuitry and memory circuitry that stores code. The processing system may be configured to cause the first wireless device to identify respective quality information associated with each RU of a set of multiple RUs that span a frequency bandwidth, transmit, in accordance with the respective quality information, information signaling that indicates a first MCS, a first modulation pattern, or both, to be applied to a first RU of the set of multiple RUs and a second MCS, a second modulation pattern, or both, to be applied to a second RU, where the first MCS differs from the second MCS, and where the first modulation pattern differs from the second modulation pattern, communicate, in accordance with the information signaling, one or more first bits of a first service data unit via the first RU using the first MCS, the first modulation pattern, or both, and communicate, in accordance with the information signaling, one or more second bits, of the first service data unit or of a second service data unit, via the second RU using the second MCS, the second modulation pattern, or both.

Another first wireless device for wireless communications is described. The first wireless device may include means for identifying respective quality information associated with each RU of a set of multiple RUs that span a frequency bandwidth, means for transmitting, in accordance with the respective quality information, information signaling that indicates a first MCS, a first modulation pattern, or both, to be applied to a first RU of the set of multiple RUs and a second MCS, a second modulation pattern, or both, to be applied to a second RU, where the first MCS differs from the second MCS, and where the first modulation pattern differs from the second modulation pattern, means for communicating, in accordance with the information signaling, one or more first bits of a first service data unit via the first RU using the first MCS, the first modulation pattern, or both, and means for communicating, in accordance with the information signaling, one or more second bits, of the first service data unit or of a second service data unit, via the second RU using the second MCS, the second modulation pattern, or both.

A non-transitory computer-readable medium storing code for wireless communications is described. The code may include instructions executable by one or more processors to identify respective quality information associated with each RU of a set of multiple RUs that span a frequency bandwidth, transmit, in accordance with the respective quality information, information signaling that indicates a first MCS, a first modulation pattern, or both, to be applied to a first RU of the set of multiple RUs and a second MCS, a second modulation pattern, or both, to be applied to a second RU, where the first MCS differs from the second MCS, and where the first modulation pattern differs from the second modulation pattern, communicate, in accordance with the information signaling, one or more first bits of a first service data unit via the first RU using the first MCS, the first modulation pattern, or both, and communicate, in accordance with the information signaling, one or more second bits, of the first service data unit or of a second service data unit, via the second RU using the second MCS, the second modulation pattern, or both.

In some examples of the method, first wireless devices, and non-transitory computer-readable medium described herein, identifying the respective quality information may include operations, features, means, or instructions for receiving a feedback message indicating respective feedback information associated with each RU of the set of multiple RUs that span the frequency bandwidth, where the respective feedback information includes the respective quality information associated with each RU of the set of multiple RUs.

In some examples of the method, first wireless devices, and non-transitory computer-readable medium described herein, each respective feedback information indicates, for an associated RU of the set of multiple RUs, one or more of an interference metric, a suggested MCS, a suggested modulation pattern, a respective RU based bit error or packet error metric, or any combination thereof.

In some examples of the method, first wireless devices, and non-transitory computer-readable medium described herein, the frequency bandwidth satisfies a bandwidth threshold and the first RU and the second RU each satisfy a RU size threshold.

In some examples of the method, first wireless devices, and non-transitory computer-readable medium described herein, the first RU spans a first set of frequency carriers of the frequency bandwidth and a second set of frequency carriers of the frequency bandwidth and the second RU spans at least a third set of frequency carriers that may be at a higher frequency than the first set of frequency carriers and a lower frequency than the second set of frequency carriers.

In some examples of the method, first wireless devices, and non-transitory computer-readable medium described herein, the first RU spans a first set of frequency carriers of the frequency bandwidth and the second RU spans a second set of frequency carriers that may be lower in frequency than the first set of frequency carriers or higher in frequency than the first set of frequency carriers.

In some examples of the method, first wireless devices, and non-transitory computer-readable medium described herein, and the method, apparatuses, and non-transitory computer-readable medium may include further operations, features, means, or instructions for a link type indicator that indicates whether the information signaling may be associated with a configuration for uplink communications or downlink communications, a first field including a data unit type indicator that indicates whether communications may be for a single service data unit or multiple service data units a compression mode indicator that indicates a compression mode of the first wireless device, a puncture channel information subfield that indicates support for RU puncturing, an anchor RU indication subfield that indicates an anchor RU, a user field that indicates the first MCS, the first modulation pattern, or both to be applied to the first RU based on the first RU being the anchor RU, or one or more fields indicating a relationship of the second RU relative to the first RU, where the one or more fields indicating the relationship may be included in an ultra high reliability (UHR) signature (SIG) common field of the information signaling.

In some examples of the method, first wireless devices, and non-transitory computer-readable medium described herein, a RU combination field that indicates respective frequency carriers associated with the first RU and the second RU, an MCS pattern field that indicates an MCS offset, where the second MCS applied to the second RU may be equal to the MCS offset relative to the first MCS, or a modulation pattern field that indicates a modulation pattern offset, where the second modulation pattern applied to the second RU may be equal to the modulation pattern offset relative to the first modulation pattern.

In some examples of the method, first wireless devices, and non-transitory computer-readable medium described herein, the information signaling includes at least a first user field and a second user field and a first station identification in the first user field may be a same station identification as a second station identification in the second user field, the first user field associated with the first RU that indicates the first MCS, the first modulation pattern, or both, and the second user field associated with the second RU that indicates the second MCS, the second modulation pattern, or both.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports signaling support for multiple coding schemes to a single user device spanning a frequency domain.

FIG. 3 shows an example of a single physical layer convergence protocol (PLCP) service data unit (PSDU) encoding procedure that supports signaling support for multiple coding schemes to a single user device spanning a frequency domain.

FIG. 4 shows an example of a single PSDU encoding procedure that supports signaling support for multiple coding schemes to a single user device spanning a frequency domain.

FIGS. 5A and 5B each show an example of a multi-resource unit (RU) configuration design that supports signaling support for multiple coding schemes to a single user device spanning a frequency domain.

FIG. 6 shows an example of a process flow that supports signaling support for multiple coding schemes to a single user device spanning a frequency domain.

FIG. 7 shows a block diagram of an example wireless communication device that supports signaling support for multiple coding schemes to a single user device spanning a frequency domain.

FIG. 8 shows a flowchart illustrating an example process performable by or at a first wireless device that supports signaling support for multiple coding schemes to a single user device spanning a frequency domain.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some examples of wireless communication networks, a transmitter device may transmit data to a single user device in accordance with a modulation and coding scheme (MCS). A given MCS may be associated with a type of modulation pattern (e.g., quadrature amplitude modulation (QAM), quadrature phase shift keying (QPSK), binary phase shift keying (BPSK), etc.) and a code rate (e.g., a ratio indicating a number of redundant bits included in a service data unit). In some cases, it may be advantageous for the transmitter device to transmit different portions of data using different resource units (RUs) or different multiple resources units (MRUs). For example, the transmitter device may transmit a first portion of a first service data unit on a first RU (or first MRU) and transmit a second portion of the first service data unit on a second RU (or second MRU). In some cases, however, different RUs may be associated with different levels of quality (e.g., a different signal to noise ratio (SNR)), and it may be advantageous to use different (e.g., unequal) MCSs for different RUs. In some cases, the different MCSs for different RUs may have different code rates and modulation orders. In some cases, the different MCS for different RUs may share the same code rate and have different modulation orders. However, without signaling that indicates unequal MCS across RUs to the single user device, the single user device may be unable to receive one or more service data units encoded using multiple unequal MCSs.

In some implementations of the present disclosure, a wireless communications network may support the use of unequal MCSs across multiple RUs. For example, the transmitter device may include in a physical (PHY) preamble, an indication of a set of MCSs corresponding to set of RUs (e.g., two RUs). In some cases, the transmitter device may include indication of each unequal MCS using a respective user info field (UIF), where each UIF includes an identification of the single user device. In some other cases, the transmitter device may indicate each of the unequal MCSs in the corresponding RU in a single user specific field (USF). In some examples, the transmitter device may determine the MCS and a modulation pattern for each RU based on identifying respective quality information (e.g., channel metric, such as signal-to-interference-and-noise ratio (SINR), per RU) associated with each RU of the set of RUs across a frequency bandwidth. For instance, the transmitter may receive from a single user device a feedback message that includes respective feedback information (e.g., quality information) for each RU of a set of RUs across a frequency bandwidth. In some examples, the feedback information for each RU may include a respective interference metric, a respective SINR, a respective suggested MCS, a respective suggested modulation pattern, or any combination thereof.

In some examples of trigger based (TB) PHY protocol data unit (PPDU) transmissions, the transmitted device may encode data in accordance with the MCSs indicated in a previous trigger frame. In some examples of multi-user (MU) PHY protocol data unit (PPDU) transmissions the transmitter device may encode data in accordance with the MCSs indicated in the PHY preamble. For example, the transmitter device may first prepare a service data unit (e.g., a PHY layer convergence protocol (PLCP) service data unit (PSDU)) for a given user in a medium access control (MAC) layer. As such, the transmitter device may encode the PSDU in the PHY layer. In some cases, the transmitter device may encode the entire PSDU using a same code rate and then parse the encoded bits into portions, where each portion may correspond to an RU, where the size of each portion is proportional to the product of two quantities, where the first quantity is the quantity of data subcarriers of the given RU, and the second quantity is the summation of the data rate of the per spatial stream MCS (or the modulation order of the per spatial stream MCS) summed across the quantity of spatial streams for the user in the given RU. In some cases, the transmitter device may encode the entire PSDU using a same code rate and then parse the encoded bits into portions, where each portion may correspond to an RU, where the size of each portion is proportional to the product of the quantity of data subcarriers of the given RU, the data rate of the MCS (or the modulation order of the MCS), and the quantity of spatial streams for the user in the given RU, if all spatial streams for the user in the given RU use the same MCS. In some cases, the transmitter device may parse the uncoded PSDU into portions, where each portion corresponds to a respective encoder associated with a respective MCS, if all spatial streams for the user in the given RU use the same MCS, or a respective set of MCS, where each MCS in the respectively set is used for one spatial stream. Additionally, or alternatively, the transmitter device may perform multiple-PSDU transmissions for a given user, where a first PSDU is transmitted via a the first RU (or first MRU) in accordance with a first MCS (or a first set of MCS, where each MCS in the set is used for one spatial stream in the first RU (or first MRU)) and a second PSDU is transmitted via a second RU (or second MRU) in accordance with a second MCS (or a second set of MCS, where each MCS in the set is used for one spatial stream in the second RU (or second MRU)).

Particular aspects of the subject matter described in this disclosure can be implemented to realize one or more of the following potential advantages. For example, in scenarios in which the transmitter device may encode portions data across multiple RUs using unequal MCS, the transmitter device and single user device may benefit from better link adaptation according to channel qualities in different RUs. For example, based on different RUs being associated with different levels of channel quality (e.g., channel gain, interference, etc.), applying respective MCSs to each RU may improve the overall throughput on multiple RUs (portions).

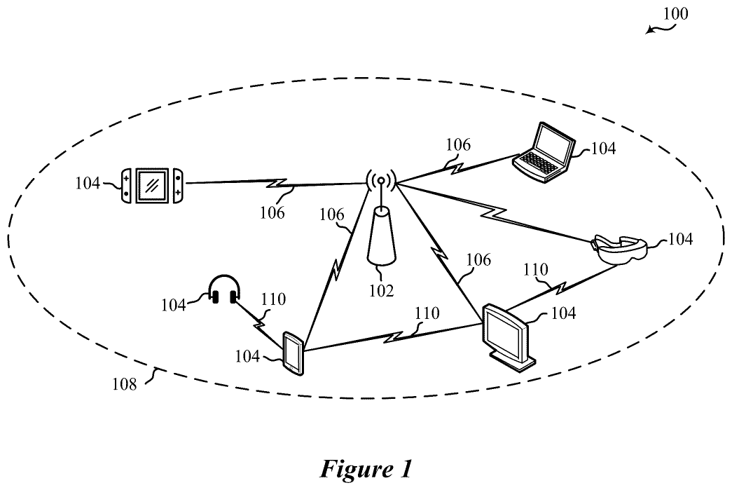

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Transmitting and receiving devices AP 102 and STA 104 may support the use of various MCSs to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

In some examples of wireless communication network 100, a transmitter device (e.g., an AP 102 or an STA 104) may transmit data to a single user device in accordance with an MCS. A given MCS may be associated with a type of modulation pattern (e.g., QAM, QPSK, BPSK, etc.) and a code rate (e.g., a ratio indicating a quantity of redundant bits included in a service data unit). In some cases, it may be advantageous for the transmitter device to transmit different portions of data using different RUs. For example, the transmitter device may transmit a first portion of a first service data unit on a first RU and transmit a second portion of the first service data unit on a second RU. In some cases, however, different RUs may be associated with different levels of quality (e.g., a different SNR), and it may be advantageous to use different (e.g., unequal) MCSs for different RUs. However, without signaling that indicates unequal MCS across RUs to the single user device, the single user device may be unable to receive one or more service data units encoded using multiple unequal MCSs.

In some implementations of the present disclosure, a wireless communications network may support the use of unequal MCSs across multiple RUs. For example, the transmitter device may include in a PHY preamble, an indication of a set of MCSs corresponding to set of RUs (e.g., two RUs). In some cases, the transmitter device may include indication of each unequal MCS using a UIF, where each UIF includes an identification of the single user device. In some other cases, the transmitter device may indicate each of the unequal MCSs in the corresponding RU in a single USF. In some examples, the transmitter device may determine the MCS and a modulation patter for each RU based on identifying respective quality information associated with each RU of the set of RUs across a frequency bandwidth. For instance, the transmitter may receive from a single user device a feedback message that includes respective feedback information for each RU of a set of RUs across a frequency bandwidth. In some examples, the feedback information for each RU may include a respective interference metric, a respective suggested MCS, a respective suggested modulation pattern, or any combination thereof.

The transmitter device may encode data in accordance with the MCSs indicated in the PHY preamble. For example, the transmitter device may first prepare a service data unit (e.g., a PSDU) in a MAC layer. As such, the transmitter device may encode the PSDU in the PHY layer. In some cases, the transmitter device may encode the entire PSDU using a same code rate and then parse the encoded bits into portions, where each portion may correspond to an RU, where the size of each portion is proportional to the product of two quantities, where the first quantity is the quantity of data subcarriers of the given RU, and the second quantity is the summation of the data rate of the per spatial stream MCS (or the modulation order of the per spatial stream MCS) summed across the quantity of spatial streams for the user in the given RU. In some cases, the transmitter device may encode the entire PSDU using a same code rate and then parse the encoded bits into portions, where each portion may correspond to an RU, where the size of each portion is proportional to the product of the quantity of data subcarriers of the given RU, the data rate of the MCS (or the modulation order of the MCS), and the quantity of spatial streams for the user in this given RU. In some cases, the transmitter device may parse the uncoded PSDU into portions, where each portion corresponds to a respective encoder associated with a respective MCS, if all spatial streams for the user in the given RU use the same MCS, or a respective set of MCS, where each MCS in the respectively set is used for one spatial stream. Additionally, or alternatively, the transmitter device may perform multiple-PSDU transmissions for a given user, where a first PSDU is transmitted via a the first RU (or first MRU) in accordance with a first MCS (or a first set of MCS, where each MCS in the set is used for one spatial stream in the first RU (or first MRU)) and a second PSDU is transmitted via a second RU (or second MRU) in accordance with a second MCS (or a second set of MCS, where each MCS in the set is used for one spatial stream in the second RU (or second MRU)).

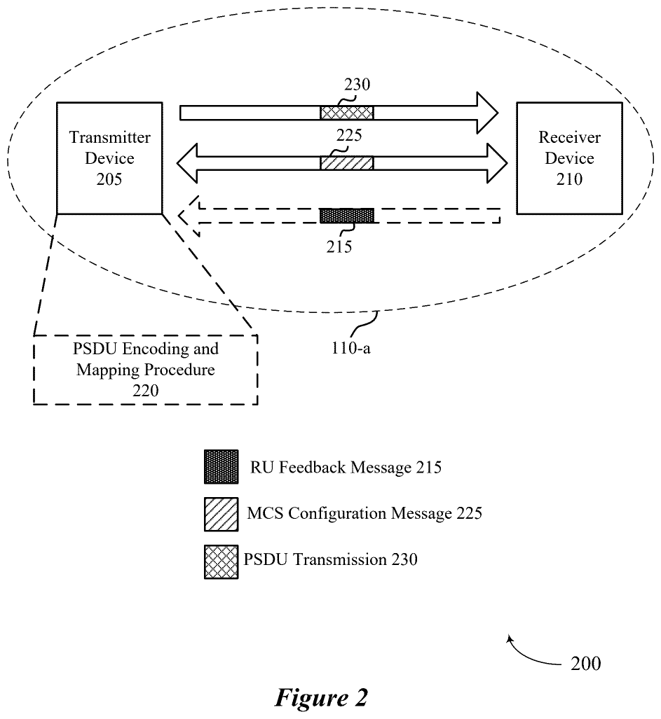

FIG. 2 shows an example of a signaling diagram 200 that supports signaling support for multiple coding schemes to a single user device spanning a frequency domain. In some examples, signaling diagram 200 may implement or be implemented by one or more aspects of wireless communication network 100. For example, signaling diagram 200 may include a transmitter device 205 and a receiver device 210 which may be examples of an AP 102, an STA 104, or both as described with reference to FIG. 1. Additionally, the transmitter device 205 and the receiver device 210 may communicate within the coverage area 110-a, which may represent a BSA of the signaling diagram 200.

In some examples, the signaling diagram 200 may support UHR MU PPDU transmissions. For example, UHR MU PPDU may include downlink OFDMA transmissions, downlink non-OFDMA MU-MIMO transmissions, non-OFDMA transmission to a single user that is not addressed to an AP 102 (e.g., downlink or point-to-point between two non-AP STAs 104), non-OFDMA transmission to a single user that is an AP 102 (e.g., uplink transmission to a single AP 102), and UHR TB PPDU (e.g., which may be trigger based and allows one or multiple non-AP STAs 104 to transmit to an AP 102 in non-OFDMA or OFDMA, non-MU-MIMO or MU-MIMO transmissions).

In some examples, transmitter device 205 may transmit data to the receiver device 210 in accordance with an MCS. An MCS may be associated with a type of modulation. For instance, a given MCS may modulate a packet of data in accordance with the techniques of QAM, QPSK, BPSK, among other examples. Additionally, the given MCS may be associated with a code rate, which may correspond to a ratio between a quantity of information bits and a total number of bits (e.g., information bits plus redundancy bits) in a PSDU transmission 230.

In some cases, it may be advantageous for the transmitter device 205 to transmit different portions of data using different RUs (e.g., bandwidth subcarrier frequencies used for UHR MU PPDU communications for open loop (OL) OFDMA transmission). For instance, the transmitter device 205 may transmit a first portion of a PSDU on a first RU and transmit a second portion of the PSDU on a second RU. In some cases, however, channel measurements across multiple RUs or sub-bands may experience large differences in channel quality across different frequencies (e.g., differences in signal to interference and noise ratio (SINR) across different RUs). As such, the transmitter device 205 may determine respective MCSs per RU to increase throughput from frequency selectivity. For instance, the first RU may correspond to a first MCS and the second RU may correspond to a second MCS. In some examples, each RU may have one or more respective spatial streams (e.g., connections made between the transmitter device 205 and the receiver device 210). In such examples, each spatial stream corresponding to a same RU may be associated with the same MCS.

In some cases, the transmitter device 205 may parse an uncoded PSDU into portions, where each portion corresponds to a respective encoder associated with a respective MCS, if all spatial streams for the user in the given RU use the same MCS, or a respective set of MCS, where each MCS in the respectively set is used for one spatial stream. Additionally, or alternatively, the transmitter device 205 may perform multiple-PSDU transmissions for a given user, where a first PSDU is transmitted via a first RU (or first MRU) in accordance with a first MCS (or a first set of MCS, where each MCS in the set is used for one spatial stream in the first RU (or first MRU)) and a second PSDU is transmitted via a second RU (or second MRU) in accordance with a second MCS (or a second set of MCS, where each MCS in the set is used for one spatial stream in the second RU (or second MRU)).

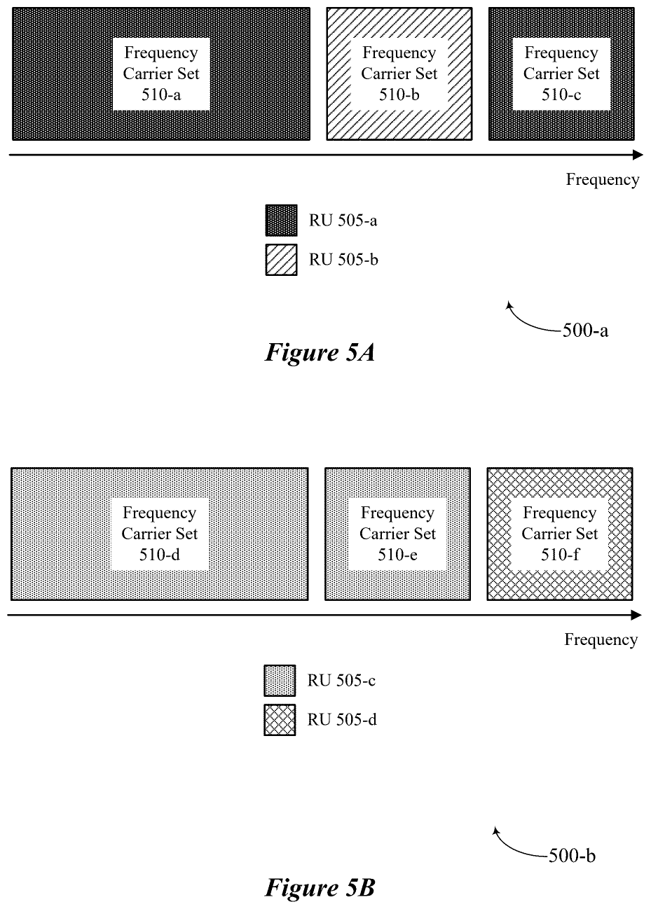

In some examples, the transmitter device 205 and receiver device 210 may communicate using MRU communications. As such, in both RU and MRU communications, the RUs or MRUs may be split into RU components or MRU components, where each RU component or MRU component may correspond to a respective MCS and each respective MCS may be different for different RU components. That is, an RU may be split into RU components or MRU components, and an MRU may also be split into RU components or MRU components. In a first example, an RU4x996 may be split into an RU996 and an MRU3x996. In a second example, an MRU3x996 may be split into an RU2x996 and an RU996 or split into an MRU2x996+484 and an RU484. In some examples, the number subsequent to an RU or MRU (e.g., 996, 484, etc.) may indicate a quantity of frequency tones or subcarriers included in the RU or MRU. In some examples, the transmitter device 205 may interpose two RUs or MRUs in frequency (e.g., MRU996-[gap-484]-484 and RU484 within a 160 MHz) Further discussion of RU and MRU configuration are described herein, including with reference to FIGS. 5A and 5B.

In accordance with multiple RUs, the transmitter device 205 may support MAC layer and PHY layer processing to support unequal MCS across the multiple RUs. The transmitter device 205 may use the MAC layer to generate one or more PSDUs for transmission to the receiver device 210. In accordance with MAC payload assignments for unequal MCS, the transmitter device 205 may prepare a single PSDU for transmission to the receiver device 210, or two or more PSDUs for transmission to the receiver device 210.

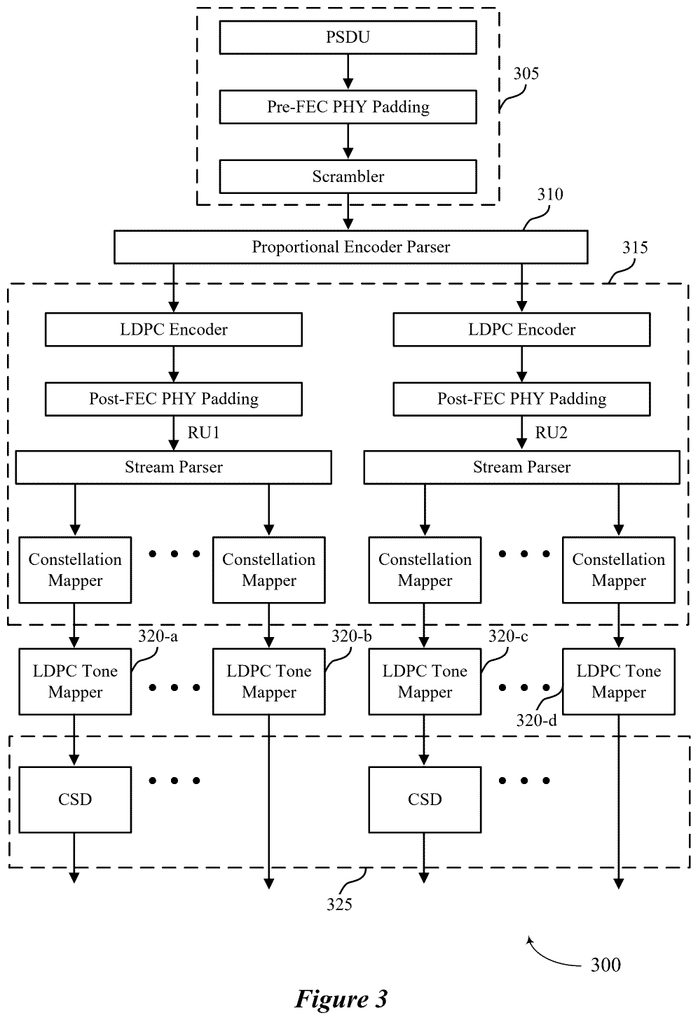

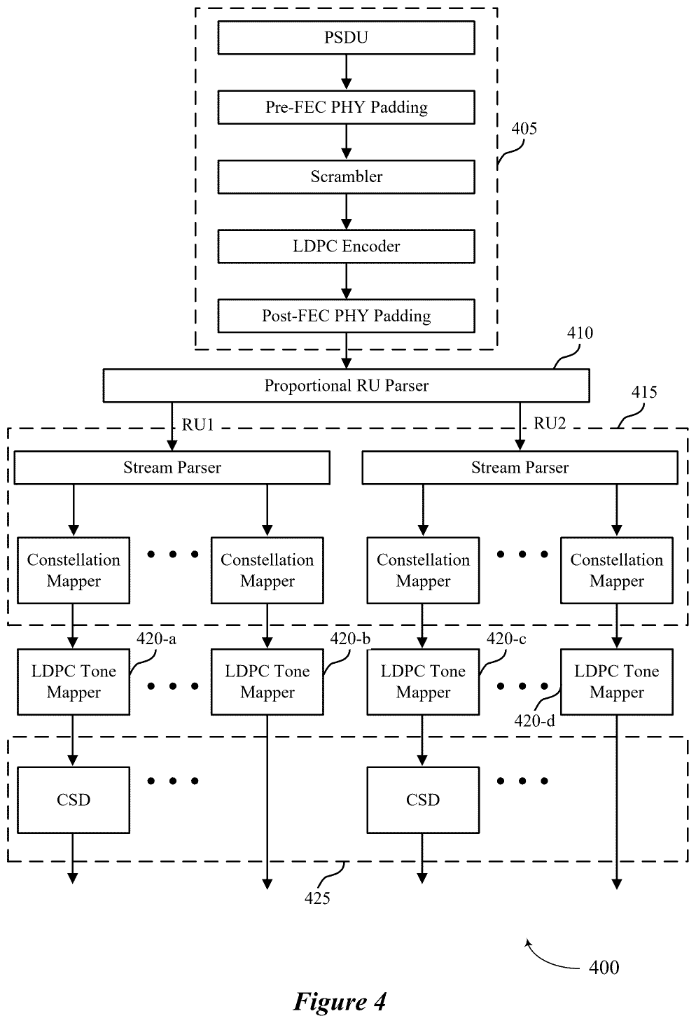

In the example of single PSDU transmissions 230, the transmitter device 205 may generate the PSDU associated to a given user in the MAC layer and encode the PSDU in the PHY layer (e.g., PSDU encoding and mapping procedure 220). In some examples, in the PHY layer, the transmitter device 205 may split the data bits across the different RUs or MRUs in accordance with the different MCSs prior to encoding. In some other examples, in the PHY layer, the transmitter device 205 may split the encoded bits across the different RUs or MRUs in accordance with the different MCSs after encoding. Additionally, or alternatively, after encoding, one or more data bits may be carried in multiple coded bits. That is, even though coded bits may be split between multiple RU components, one or more data bits may be carried in each of the RU components. In examples where each of the different MCSs have a same code rate, the transmitter device 205 may code information bits before splitting the coded bits into different RUs. In examples where each of the different MCSs have different code rates, the transmitter device 205 may split the information bits into different RUs before coding the information bits. Further discussion of encoding and mapping a single PSDU split across multiple RUs is described herein, including with reference to FIGS. 3 and 4.

In some cases, the techniques described herein may support multi-RU or multi-MRU transmission for each supported user using different MCSs and modulations patterns per RU in accordance with different transmission types. For instance, signaling diagram 200 may perform non-OFDMA single user transmission in cases where channel quality variance between different RUs or frequency sub-bands is above a threshold. Additionally, or alternatively, signaling diagram 200 may perform non-OFDMA MU-MIMO transmissions, if the quantity of spatial streams supporter at each user is below a spatial stream threshold. Additionally, or alternatively, signaling diagram 200 may perform AP-AP transmissions (e.g., where the transmitter device 205 is a first AP 102 and the receiver device 210 is a second AP 102) and support unequal MCS and unequal modulation across multiple RUs. Additionally, or alternatively, signaling diagram 200 may perform mixed bandwidth MU-MIMO transmissions, where at least one user may support two RUs, one in non-MU-MIMO transmission and the other in MU-MIMO transmission. For instance, an AP 102 may assign an STA 104 two RUs (e.g., a first RU for non-MU-MIMO transmissions and a second RU for MU-MIMO transmissions).

In some examples, the receiver device 210 may transmit an RU feedback message 215 to the transmitter device 205. For instance, legacy signal-to-noise ratio (SNR) (e.g., channel quality indicator (CQI)) feedback may indicate channel variation but may not indicate interference variation across frequency (e.g., across different RUs). For example, in multi-PSDU, separate link adaptation is done for different PSDUs transmitted on different RUs (e.g., similar to multiple users in OFDMA). Additionally, in single-PSDU the legacy packet error rate (PER) based link adaptation may not work with respect to different RUs for a multi-RU transmission with unequal MCS or unequal modulation. Because the PER is a metric of the entire PSDU, and different RU components or MRU components may have different contributions to the PER. If a packet failed, it is not clear if which RU component(s) or MRU component(s) suffer from bad channel quality due to interference. With reference multi-RU unequal MCS with a single PSDU and separate encoding in different RU components or MRU components, may add per RU component or per MRU component based bit error or packet error metric feedback for per RU component or per MRU component link adaptation. Additionally, with reference multi-RU unequal modulation, legacy PER based link adaptation may not work due to joint encoding across different RUs. As such, the receiver device 210 may measure interference for a set of RUs across a frequency bandwidth and transmit interference information in the RU feedback message 215. In some examples, the RU feedback message 215 may include respective quality information associated with each RU of the set of RUs across a frequency bandwidth. For instance, the respective quality information for each RU may include a respective interference metric (e.g., interference and noise power, SNR, CQI, SINR, among other examples), a respective suggested MCS, a respective suggested modulation pattern (e.g., equal modulation, unequal modulation), or any combination thereof.

In some examples, the RU feedback message 215 may be an optional transmission at the receiver device 210. For instance, the receiver device 210 may transmit the RU feedback message 215 in cases where the transmitter device 205 is an AP 102 and the receiver device 210 is an STA 104 serviced by the AP 102 (e.g., PSDU transmissions 230 from the AP 102 to the STA 104). In such cases, the AP 102 may be unaware of quality metrics associated with each RU for multi-RU PSDU transmissions. As such, the RU feedback message 215 may indicate to the AP 102 respective quality information associated with each of the set of RUs, where the AP 102 may use the respective quality information in determination of an MCS configuration for subsequent multi-RU PSDU transmissions. In cases where the transmitter device 205 is an STA 104 and the receiver device 210 is an AP 102 that services the STA 104 (e.g., PSDU transmission 230 from the STA 104 to the AP 102), then the receiver device 210 may refrain from transmitting the RU feedback message 215. For instance, the AP 102 may identify the respective quality information associated with each of the set of RUs based on receiving and measuring previous multi-RU PSDU transmissions from the STA 104.

In some other examples, the transmitter device 205 may perform a CCA in accordance with open loop communications. For instance, CCA may be technique used in wireless communications to determine if an RU is free or occupied before transmitting data, which may reduce the occurrence of collisions and interference with other ongoing transmissions. In some examples, the CCA may include a listening phase, an RU assessment phase, and a decision-making phase. In accordance with the listening phase, the transmitter device 205 may listen to across the set of RUs and detect any ongoing transmissions. In accordance with the RU assessment phase, the transmitter device 205 may measure the energy or signal strength for each RU of the set of RUs to determine if a given RU is being used. In accordance with the decision-making phase, if energy detected for a given RU is below a certain threshold, the RU may be considered clear for transmission, and if the energy detected for the given RU is above the threshold, the RU may be considered occupied for transmission. Additionally, or alternatively, the transmitter device 205 may determine a suggested MCS and modulation pattern to use for each RU of the set of RUs based on the measurements performed for each RU during the CCA. As such, the transmitter device 205 may use CCA to determine the respective quality information for each RU of the set of RUs. In some examples, the transmitter device 205 may perform CCA rather than receiving the RU feedback message 215 from the receiver device 210.

To support decoding of PSDUs encoded using unequal MCSs across multiple RUs, the transmitter device 205 or receiver device 210 may transmit an MCS configuration message 225. For example, the AP 102 may transmit the MCS configuration message 225. That is, in cases where the AP 102 is the transmitter device 205 (e.g., during PSDU transmissions 230), the transmitter device 205 may transmit the MCS configuration message 225, and in cases where the AP 102 is the receiver device 210 (e.g., during PSDU transmissions 230), the receiver device 210 may transmit the MCS configuration message 225.

In some examples, the MCS configuration message 225 may be an example of a PHY preamble included in information signaling for PHY layer configuration. In some cases, the PHY preamble may include multiple signatures (SIGs), where the SIGs may be examples of UIFs. For instance, and in examples of ultra-high reliability (UHR), the PHY preamble may include a universal SIG (U-SIG), a UHR-SIG, an EHT SIG (EHT-SIG), among other examples. As such, the fields of the MCS configuration message 225 may support indication of unequal MCS or unequal modulation to the STA 104 (e.g., for receiving or transmitting UHR MU PPDU). In some examples, RU configuration may be carried in a common information field in the UHR-SIG, in a common information field in the EHT-SIG, or both. In some examples, a SIG field (e.g., an EHT-SIG field) may include a multiple parts. For example, the EHT-SIG may include a common field that may carry information for multiple users (e.g., information common across multiple receiver devices 210 communicating with the transmitter device 205). Additionally, the EHT-SIG may include a USF that includes at least one UIF, where each UIF field in the USF includes information corresponding to a single user. As described herein, the MCS configuration message 225 may be associated with one or more implementations associated with configuration unequal MCS or unequal modulation across multiple RUs for UHR MU PPDU transmissions.

In a first implementation, the MCS configuration message 225 may be associated with non-MU-MIMO and MU-MIMO transmissions in an UHR MU PPDU. For example, the MCS configuration message 225 may be for OFDMA with two user fields. For instance, the MCS configuration message 225 may indicate an OFDMA transmission mode associated with configurations for an MU PPDU, which may include an RU allocation table to indicate assigned RUs. In some examples, the signaling overhead associated with OFDMA may be a quantity of bits (e.g., 9 bits) per RU allocation subfield (e.g., per 20 MHz) per content channel. In some examples, the two user fields of the MCS configuration message 225 may include a same STA 104 identifier for a single user (e.g., the identifier associated with the receiver device 210). In some examples, the MCS configuration message 225 may be used for mixed bandwidth MU-MIMO. In some examples, the MCS configuration message 225 may indicate puncturing support through a punctured RU indication in the RU allocation subfields. In some examples, the first user field may indicate a first MCS associated with a first RU and the second user field may indicate a second MCS different from the first MCS for the second RU (e.g., for unequal MCS or unequal modulation where the two MCSs are associated with the same code rate). Additionally, or alternatively, the first user field may indicate a first modulation pattern associated with a first RU and the second user field may indicate a second modulation pattern different from the first modulation pattern for the second RU (e.g., for unequal modulation).

In a second implementation, the MCS configuration message 225 may be associated with non-OFDMA single user transmissions. For example, the MCS configuration message 225 may be applicable to non-OFDMA but may not be applicable to mixed bandwidth MU-MIMO. In some cases of the second implementation, the MCS configuration message 225 may include a compressed format for non-OFDMA single user communications. For example, the MCS configuration message 225 may indicate the compressed format via combination of an uplink/downlink bit and PPDU type and compression mode field. In some examples, the PPDU type and compression mode may be a mode that indicates transmission to a single user associated with unequal MCS, unequal modulation pattern, or both for two RUs. In some examples, the MCS configuration message 225 may include a puncture channel information subfield in the U-SIG field. In some examples, the MCS configuration message 225 may include a user field for indicating non-MU-MIMO communications in the user field format. Such a non-MU-MIMO user field may include a quantity of bits (e.g., 23 bits). In some examples, the user field may carry signaling for the receiver device 210 over frequencies of a first RU or first MRU which may serve as an anchor RU or anchor MRU, where second information associated with a second RU or second MRU may be relative to first information of the first RU or first MRU. In some examples, the anchor RU or anchor MRU may be configured as the RU or MRU that is at a higher frequency or lower frequency relative to the second RU or second MRU. In some examples, if the anchor RU or anchor MRU may be defined to be always the RU or MRU that is at a higher frequency or lower frequency relative to the second RU or second MRU, no signaling is needed to indicate which RU or MRU is the anchor RU or anchor MRU. In some examples, the user field may indicate a first MCS, a first modulation pattern, or both associated with the anchor RU or anchor MRU.

In some examples of a single user transmission mode the RU combination and the anchor RU or anchor MRU may be jointly indicated by a bitmap. For example, in the bitmap, a value of 1 indicates the anchor RU (MRU) or portion whose signaling is carried in the user field; value 0 indicates the other RU (MRU) or portion. In a first instance, a 2-bit bitmap may indicate a lower and an upper half of the PPDU bandwidth (and the corresponding (M)RUs or portions). In some cases, the 2-bit bitmap may reduce to 1 bit if there are only two (M)RUs or portions, with value 1 or 0 indicating the lower or upper (M)RU component or portion is the anchor. In a second instance, a 4-bit bitmap may indicate for up to four 80 MHz frequency subblocks in 320 MHz, where each bit in the 4-bit bitmap corresponds to one 80 MHz frequency subblock, in a certain order. For example, the order of the 4 bits may be associated to 80 MHz frequency subblocks from the lowest to the highest frequency. If there may be up to 4 RU or MRU components in the split, there may be only one value in the 4-bit bitmap equal to 1 to indicate the anchor RU or anchor MRU. And the other three values of 0 indicate other RUs or other MRUs. For example, if there are up to 4 RU or MRU components in 320 MHz, and the 4-bit bitmap takes the value of [0 1 0 0], the anchor RU or anchor MRU is in the second lowest 80 MHz frequency subblock, while three other RUs or MRUs are in the lowest 80 MHz frequency subblock, third lowest 80 MHz frequency subblock, and the highest 80 MHz frequency subblock. If no puncturing is in the second lowest 80 MHz frequency subblock, the anchor RU is the second lowest RU996. The punctured channel information is indicated in the punctured channel information subfield. If there is puncturing in the second lowest 80 MHz frequency subblock, for example, if the third lowest 40 MHz is punctured in the 320 MHz PPDU, the anchor RU is the fourth lowest RU484. The other RUs or MRUs are determined in the same way, according to the punctured channel information indicated in the punctured channel information subfield. If there may be up to 2 RU or MRU components in the split, the combination of the values of 1 in the 4-bit bitmap may jointly indicate the anchor RU or anchor MRU, while the combinations of the values of 0 in the 4-bit bitmap may jointly indicate the other RU or MRU. For example, in an unpunctured 320 MHz PPDU, if the 4-bit bitmap takes the value of [0 1 1 1], the 3x996-tone MRU−1 as defined in the IEEE 802.11be specification is the anchor MRU, which spans the second lowest 80 MHz frequency subblock, third lowest 80 MHz frequency subblock and the highest 80 MHz frequency subblock, and the lowest RU996 is the other RU. In some cases, the first two bits of the 4-bit bitmap may be used for 80 MHz or 160 MHz PPDU, to represent the lower and upper half of the PPDU bandwidth (and the corresponding RUs or MRUs), and the other two bits may be reserved.

As part of the second implementation of the MCS configuration message 225, information associated with the indicating unequal MCS and unequal modulation pattern for the first RU and second RU may be included within the version dependent portion of the U-SIG field, included within the UHR-SIG common field, or both. For example, the U-SIG field, the UHR-SIG common field, or both may include one or more of an RU combination field, an anchor RU, MRU or portion indication, a unequal MCS pattern field, or a unequal modulation pattern field. The RU combination field may be a field that indicates the RU combination. For instance, the field may include a set of bits (e.g., three bits), where each respective value of the set of bits indicates a respective RU combination for the given PPDU bandwidth. Further discussions of the respective RU combinations are described herein, including with reference to FIGS. 5A and 5B. The anchor RU, MRU or portion indication field may be omitted if the anchor RU or anchor MRU or anchor portion is not configurable but determined based on the RU combination or the split. For example, given an RU combination or split, the anchor RU, MRU or portion may be defined to be the RU or MRU of lower frequency compared to the other RU or MRU. The unequal MCS pattern field may be a set of bits (e.g., three bits) where each respective value of the set of bits indicates an MCS offset associated with the second RU relative to the first MCS of the anchor RU (e.g., MCS−3, MCS−2, MCS−1, MCS, MCS+1, MCS+2, MCS+3, etc., where MCS−x is x level down compared to the MCS indicated in the user field for the anchor RU, and MCS+x is x level up compared to the MCS indicated in the user field for the anchor RU). Note that the MCS offset “+x” or “−x” level may not be according to the MCS indices if the data rate is not in a monotonically increasing order according to the MCS index. The MCS offset level may be according to the reordered MCS level according to a data rate monotonically increasing order. The unequal modulation pattern field may be a set of bits (e.g., three bits) where each respective value of the set of bits indicates a modulation pattern offset associated with the second RU relative to the first modulation pattern of the anchor RU (e.g., QAM−3, QAM−2, QAM−1, QAM, QAM+1, QAM+2, QAM+3, etc., where QAM−x is x level down compared to the modulation associated to the MCS indicated in the user field for the anchor RU, and QAM+x is x level up compared to the modulation associated to the MCS indicated in the user field for the anchor RU). The 7 QAM levels from the lowest to highest may be BPSK, QPSK, 16QAM, 64QAM, 256QAM, 1024QAM and 4096QAM. In some examples, the unequal MCS pattern field may be a set of bits (e.g., two bits) where each respective value of the set of bits indicates an MCS offset associated with the second RU relative to the first MCS of the anchor RU (e.g., MCS−1, MCS, MCS+1, etc, where MCS−x is x level down compared to the MCS indicated in the user field for the anchor RU, and MCS+x is x level up compared to the MCS indicated in the user field for the anchor RU). The unequal modulation pattern field may be a set of bits (e.g., 2 bits) where each respective value of the set of bits indicates a modulation pattern offset associated with the second RU relative to the first modulation pattern of the anchor RU (e.g., QAM−1, QAM, QAM+1, etc., where QAM−x is x level down compared to the modulation associated to the MCS indicated in the user field for the anchor RU, and QAM+x is x level up compared to the modulation associated to the MCS indicated in the user field for the anchor RU).

In some examples of a single user transmission mode, the anchor RU, MRU, or portion configurable, and not determined based on the RU combination or split. For example, the anchor RU, MRU, or portion may be the one that has the highest or lowest MCS or QAM. The anchor RU, MRU or portion indication field may use a set of bits to indicate the anchor RU, MRU or portion. For example, the anchor RU, MRU or portion indication field may use 1 bit to indicate which RU, MRU or portion out of two RUs, MRUs, or portions in the RU combination is the anchor RU, MRU or portion, if there are up to two RUs, MRUs, or portions in the split. In another example, the anchor RU, MRU or portion indication field may use 2 bits to indicate which RU, MRU or portion out of up to four RUs, MRUs, or portions in the RU combination is the anchor RU, MRU or portion, if there are up to four RUs, MRUs, or portions in the split. In cases where the anchor RU, MRU, or portion is the one with highest MCS or QAM, the MCS configuration message 225 may include 2 bits in the “unequal MCS pattern” field for unequal MCS to signal a second MCS of the other RU, MRU, or portion relative to the first MCS of the anchor RU (e.g., MCS−3, MCS−2, MCS−1, MCS, where MCS is the MCS in the anchor (M)RU or portion, and MCS−x is x level down compared to the MCS indicated in the user field for the anchor RU). In another example, in cases where the anchor RU, MRU, or portion is the one with highest MCS or QAM, the MCS configuration message 225 may include 1 bit in the “unequal MCS pattern” field for unequal MCS to signal a second MCS of the other RU, MRU, or portion relative to the first MCS of the anchor RU (e.g., MCS−1, MCS, where MCS is the MCS in the anchor (M)RU or portion, and MCS−x is x level down compared to the MCS indicated in the user field for the anchor RU). Additionally, or alternatively, the MCS configuration message 225 may include 2 bits in the “unequal modulation pattern” field for unequal modulation pattern to signal the second QAM of the second RU, MRU, or portion relative to the first modulation pattern of the anchor RU (e.g., QAM−3, QAM−2, QAM−1, QAM, where QAM is the modulation order in the MCS in the anchor RU, MRU, or portion, and QAM−x is x level down compared to the modulation associated to the MCS indicated in the user field for the anchor RU). In another example, the MCS configuration message 225 may include 1 bit in the “unequal modulation pattern” field for unequal modulation pattern to signal the second QAM of the second RU, MRU, or portion relative to the first modulation pattern of the anchor RU (e.g., QAM−1, QAM, where QAM is the modulation order in the MCS in the anchor RU, MRU, or portion, and QAM−x is x level down compared to the modulation associated to the MCS indicated in the user field for the anchor RU). In cases where the anchor RU, MRU, or portion is the RU with the lowest MCS or QAM, the MCS configuration message 225 may include 2 bits in the “unequal MCS pattern” field for unequal MCS to signal the MCS of the second RU, MRU, or portion relative to the first MCS of the anchor RU (e.g., MCS, MCS+1, MCS+2, MCS+3, where MCS is the MCS in the anchor RU, MRU, or portion, and MCS+x is x level up compared to the MCS indicated in the user field for the anchor RU). In another example, In cases where the anchor RU, MRU, or portion is the RU with the lowest MCS or QAM, the MCS configuration message 225 may include 1 bit in the “unequal MCS pattern” field for unequal MCS to signal the MCS of the second RU, MRU, or portion relative to the first MCS of the anchor RU (e.g., MCS, MCS+1, where MCS is the MCS in the anchor RU, MRU, or portion, and MCS+x is x level up compared to the MCS indicated in the user field for the anchor RU). Additionally, or alternatively, the MCS configuration message 225 may include 2 bits in the “unequal modulation pattern” field for unequal modulation pattern to signal the second QAM of the second RU, MRU, or portion relative to the first modulation pattern of the anchor RU (e.g., QAM+3, QAM+2, QAM+1, QAM, where QAM is the modulation order in the MCS in the anchor RU, MRU, or portion, and QAM+x is x level up compared to the modulation associated to the MCS indicated in the user field for the anchor RU). In another example, the MCS configuration message 225 may include 1 bit in the “unequal modulation pattern” field for unequal modulation pattern to signal the second QAM of the second RU, MRU, or portion relative to the first modulation pattern of the anchor RU (e.g., QAM+1, QAM, where QAM is the modulation order in the MCS in the anchor RU, MRU, or portion, and QAM+x is x level up compared to the modulation associated to the MCS indicated in the user field for the anchor RU).

As part of the second implementation of the MCS configuration message 225, the UHR-SIG may be associated with a transmission to a single user mode (e.g., in two symbols if transmitted in MCSO). The U-SIG and the EHT-SIG or UHR-SIG in the transmission to a single user mode may include a total 12 reserved bits (e.g., validate bits and disregard bits). In some examples, the AP 102 may repurpose a bit from the 12 reserved bits for the user info filed to form 22 bits in EHT to 23 bits in UHR. In some examples, the AP 102 may repurpose a set of bits for the RU combination field, the anchor RU or MRU or portion indication field, the unequal MCS pattern field, and the unequal modulation pattern field.

In a third implementation, the MCS configuration message 225 may be associated with a non-MU-MIMO user field for non-OFDMA single user transmissions. In some examples, the third implementation of the MCS configuration message 225 may be applicable to the non-OFDMA transmissions and may not be applicable to mixed bandwidth MU-MIMO. In accordance with the third implementation, the MCS configuration message 225 may be included in one user field associated with a different non-MU-MIMO user info field format. For example, the non-MU-MIMO user field may include an MCS field that indicates the MCS for the anchor RU (e.g., the first RU of lower or higher frequency). Additionally, the non-MU-MIMO user field may include the RU combination field to indicate the RU combination (e.g., three bits). Further discussion of the respective RU combinations are described herein including with reference to FIGS. 5A and 5B. Additionally, the non-MU-MIMO user field may include the anchor RU or MRU or portion indication field (e.g., one bit) to indicate the anchor RU or MRU or portion. Additionally, the non-MU-MIMO user field may include the unequal MCS pattern field, the unequal modulation pattern field, or both, which may be used to indicated the MCS, QAM, or both, of another RU in the RU combination (e.g., non-anchor RU). Additionally, the UHR-SIG may be associated with the transmission to a single user mode (e.g., in two symbols if transmitted in MCSO). That is, the AP 102 may repurpose bits in U-SIG and the common field of UHR-SIG to accommodate a set of bits in the non-MU-MIMO user field format to indicate one or more of the RU combination field, the unequal MCS pattern field, or the unequal modulation pattern field (e.g., up to nine bits).

In a fourth implementation, the MCS configuration message 225 may be associated with a TB PPDU, e.g., a UHR TB PPDU. This implementation may have a link adaptation benefit because AP as the receiver has better knowledge of channel quality and interference information, and AP performs link adaptation and derives the MCS configuration message 225. For instance, the MCS configuration message 225 may be carried in a trigger frame preceding the TB PPDU. In accordance with the fourth implementation, the MCS configuration message 225 may include two user info fields with a same association identifier (AID) (e.g., AID12) associated with a single STA 104, as configured by the AP 102. In some examples, the fourth implementation of the MCS configuration message 225 may support mixed bandwidth MU-MIMO communications. In some examples, MCS configuration message 225 may indicate for the STA 104 to transmit PSDUs to a single user in accordance with unequal MCS, unequal modulation pattern, or both for two RUs. For example, the MCS configuration message 225 may indicate a first MCS in the first user info field associated with the first RU and a second MCS different from the first MCS in the second user info field associated with the second RU. Additionally, or alternatively, the MCS configuration message 225 may indicate a first modulation pattern in the first user info field associated with the first RU and a second modulation different from the first modulation pattern in the second user info field associated with the second RU (e.g., to indicate different MCS that share a same code rate in the two user info fields). In some examples, the MCS configuration message 225 may indicate single user transmission with unequal MCS or unequal modulation in a 1-bit field in the common info field or a special user info field in the Trigger Frame. Alternatively, the MCS configuration message 225 may indicate single user transmission with unequal MCS or unequal modulation, along with other transmission modes, for example, single user transmission without unequal MCS or unequal modulation, OFDMA transmission, non-OFDMA MU-MIMO transmission, etc. in a transmission mode field of a set of bits (e.g., 2 bits) in the common info field or a special user info field in the Trigger Frame.

As such, the transmitter device 205 may perform the PSDU encoding and mapping procedure 220 in accordance with the RU configuration indicated in the MCS configuration message 225. As such, the transmitter device 205 may proceed to transmit the one or more PSDUs prepared (e.g., using the PSDU encoding and mapping procedure 220) in a PSDU transmission 230. The receiver device 210 may receive the PSDU transmission 230 and decode the one or more PSDUs using the MCS information provided in the MCS configuration message 225.

FIG. 3 shows an example of a single PSDU encoding procedure 300 that supports signaling support for multiple coding schemes to a single user device spanning a frequency domain. In some examples, single PSDU encoding procedure 300 may implement or be implemented by one or more aspects of wireless communication network 100 and signaling diagram 200. For example, single PSDU encoding procedure 300 may be an example of the PSDU encoding and mapping procedure 220 performed by the transmitter device 205, as described with reference to FIG. 2.

As discussed with reference to FIG. 2, the transmitter device 205 may generate the single PSDU in the MAC layer. As such, the generated single PSDU may be encoded in the PHY layer. In some cases, the encoding process illustrated in single PSDU encoding procedure 300 may correspond to a case where respective RUs of an MRU are associated with respective MCSs that have different code rates. For instance, the process of FIG. 3 may illustrate two RUs, where RU1 is associated to a first MCS and RU2 is associated with a second MCS. As such, the first MCS and second MCS may have different code rates. In some examples, RU1 and RU2 may be part of an MRU. For example, the process of FIG. 3 may provide for per RU MCS for OL OFDMA transmission with MRU assignments, where separate encoding for different code rates in assigned MCSs uses a proportional encoder parser for parsing information bits for each RU proportionally to products of the respective data rate of the MCS, the respective quantity of data subcarriers of the RU size, and the quantity of spatial streams for the user in this given RU. In some cases, the transmitter device 205 may parse the uncoded PSDU into portions, where each portion corresponds to a respective encoder associated with a respective MCS, if all spatial streams for the user in the given RU use the same MCS, or a respective set of MCS, where each MCS in the respectively set is used for one spatial stream. Additionally, or alternatively, the transmitter device 205 may perform multiple-PSDU transmissions for a given user, where a first PSDU is transmitted via a the first RU (or first MRU) in accordance with a first MCS (or a first set of MCS, where each MCS in the set is used for one spatial stream in the first RU (or first MRU)) and a second PSDU is transmitted via a second RU (or second MRU) in accordance with a second MCS (or a second set of MCS, where each MCS in the set is used for one spatial stream in the second RU (or second MRU)).

In some examples, the transmitter device 205 may perform an initial PSDU preparation procedure 305 using the PHY layer. For example, the transmitter device 205 may perform pre-FEC PHY padding (e.g., padding the single PSDU with additional bits such that the quantity of bits of the single PSDU satisfies a pre-FEC bit threshold). Based on performing the pre-FEC PHY padding, the transmitter device 205 may use a scrambler (e.g., a device that transposes or inverts signals in the analog domain).

Based on the respective MCSs for each RU having different code rates, the transmitter device 205 may separate encoding for each of the RUs. For instance, the transmitter device 205 may use a proportional encoder parser 310 to parse the bits of the single PSDU into respective subsets of bits corresponding to the respective RUs. In some examples, the proportional encoder parser 310 may determine the quantity of bits as a product of the modulation order of the corresponding MCS, the respective quantity of data subcarriers of the size of the RU the given subset of bits is assigned to, and the quantity of spatial streams for the user in this given RU. In some cases, the transmitter device 205 may parse the uncoded PSDU into portions, where each portion corresponds to a respective encoder associated with a respective MCS, if all spatial streams for the user in the given RU use the same MCS, or a respective set of MCS, where each MCS in the respectively set is used for one spatial stream. Additionally, or alternatively, the transmitter device 205 may perform multiple-PSDU transmissions for a given user, where a first PSDU is transmitted via a the first RU (or first MRU) in accordance with a first MCS (or a first set of MCS, where each MCS in the set is used for one spatial stream in the first RU (or first MRU)) and a second PSDU is transmitted via a second RU (or second MRU) in accordance with a second MCS (or a second set of MCS, where each MCS in the set is used for one spatial stream in the second RU (or second MRU)).

Based on parsing the single PSDU into respective subsets of bits, the transmitter device 205 may encode the respective subsets of bits in accordance with the encoding procedure 315. For example, each respective subset of bits may be encoded using a respective encoder associated with the MCS for the corresponding RU. While FIG. 3 illustrates the use of LDPC encoding, it is understood that the techniques of FIG. 3 may use other forms of encoding such as BCC, among other examples. Based on performing the respective encoding for each subset of bits, the transmitter device 205 may perform post-FEC PHY padding (e.g., padding the respective subsets of bits with additional bits such that the quantity of bits for each of the respective subset of bits satisfies a post-FEC bit threshold).

As such, the transmitter device 205 may perform stream mapping for each of the subset of bits corresponding to the respective RUs. For instance, each RU may be associated with a respective stream parser that may parse a subset of bits into sub-subsets of bits corresponding to the spatial streams associated with the corresponding RU. As described with reference to FIG. 2, each of the spatial streams associated with a given RU may have a same MCS. Additionally, the quantity of bits in a given sub-subset of bits may be proportional to the product of the modulation order of the MCS corresponding to the RU, the quantity of data subcarriers of the given RU, and the quantity of spatial streams for the user in this given RU, and the encoded bits are parsed to each spatial stream in a round robin way. Additionally, each spatial stream may be associated with a respective constellation mapper. For instance, each constellation mapper may map the sub-subset of bits parsed to the associated spatial stream into a respective constellation size associated with the corresponding MCS for the associated RU. As such, each constellation mapper may be based on the type of modulation for the corresponding MCS (e.g., QAM, QPSK, BPSK, among other examples). It is understood that each RU may be associated with any quantity of spatial streams corresponding to any quantity of constellation mappers.

Based on mapping the bits using the respective constellation mappers, the transmitter device 205 may perform tone mapping using respective tone mappers 320 (tone mapper 320-a, 320-b, 320-c, and 320-d) associated with each spatial stream. In some examples, the transmitter device 205 may use a given tone mapper 320 to permute the stream of constellation points to obtain the corresponding spatial stream. While FIG. 3 illustrates the use LDPC tone mappers, it is understood that the techniques of FIG. 3 may use other forms of interleavers such as BCC interleavers, among other examples. Additionally, the tone mappers 320 may operate within each RU rather than within the MRU to separate given modulation schemes assigned to each RU of the MRU (e.g., to keep each QAM within its assigned RU).

Based on performing tone mapping, the transmitter device 205 may perform a PSDU procedure 325. For example, the transmitter device 205 may apply a respective circular shift delay (CSD) to one or more of the spatial streams. A CSD may be used to apply a cyclic delay to each of the spatial streams to increase the frequency diversity and reduce correlation between the transmission on each spatial steam.

FIG. 4 shows an example of a single PSDU encoding procedure 400 that supports signaling support for multiple coding schemes to a single user device spanning a frequency domain. In some examples, single PSDU encoding procedure 400 may implement or be implemented by one or more aspects of wireless communication network 100 and signaling diagram 200. For example, single PSDU encoding procedure 400 may be an example of the PSDU encoding and mapping procedure 220 performed by the transmitter device 205, as described with reference to FIG. 2.

As discussed with reference to FIG. 2, the transmitter device 205 may generate the single PSDU in the MAC layer. As such, the generated single PSDU may be encoded in the in the PHY layer. In some cases, the encoding process illustrated in single PSDU encoding procedure 400 may correspond to a case of same code rates and different modulations across respective MCSs associated with respective RUs. For instance, the process of FIG. 4 may illustrate two RUs, where RU1 is associated to a first MCS and RU2 is associated with a second MCS. As such, the first MCS and second MCS may share a same coding rate and have different modulations. In some examples, RU1 and RU2 may be part of an RU or MRU. For example, the process of FIG. 4 may provide for per RU MCS for OL OFDMA transmission with MRU assignments, where joint encoding for a same code rate but with different modulation, a proportional RU parser may be used to parse coded bits to each RU in MRU proportionally to products of the quantity of data subcarriers of the RU size, modulation order of the MCS, and the quantity of spatial streams for the user in this given RU.

Based on the respective MCSs having the same code rate, the transmitter device 205 may encode the bits of the single PSDU first and split the coded bits of the single PSDU into different RUs. In some examples, the transmitter device 205 may encode the bits in accordance with encoding procedure 405. For example, the transmitter device 205 may perform a pre-FEC PHY padding (e.g., padding the single PSDU with additional bits such that the quantity of bits of the single PSDU satisfies a pre-FEC bit threshold). Based on performing the pre-FEC PHY padding, the transmitter device 205 may use a scrambler (e.g., a device that transposes or inverts signals in the analog domain). Based on performing the scrambling, the transmitter device 205 may perform encoding on the PSDU. While FIG. 4 illustrates the use of LDPC encoding, it is understood that the techniques of FIG. 4 may use other forms of encoding such as BCC, among other examples. Based on performing the encoding, the transmitter device 205 may perform post-FEC PHY padding (e.g., padding the single PSDU with additional bits such that the quantity of bits of the single PSDU satisfies a post-FEC bit threshold). As described with reference to FIG. 4, the transmitter device 205 may encode the bits of the single PSDU prior to splitting the bits across RU1 and RU2.

Based on performing the encoding procedure 405, the transmitter device 205 may split the encoded bits of the single PSDU into subsets of bits using a proportional RU parser 410. For example, the proportional RU parser 410 may parse the coded bits into respective subsets of bits corresponding to respective RUs. In some cases, the quantity of bits in a given subset of bits may be proportional to a product of the modulation order of the corresponding MCS, the quantity of data subcarriers of the size of the RU the given subset of bits is assigned to, and the quantity of spatial streams for the user in this given RU. While FIG. 4 illustrates parsing the coded bits of the single PSDU to two RUs, it is understood that the coded bits may be parsed into any quantity of subset of bits corresponding to any quantity of RUs.

As such, the transmitter device 205 may perform a stream mapping procedure 415 for each of the subset of bits corresponding to the respective RUs. For instance, a respective stream parser may parse a subset of bits into sub-subsets of bits corresponding to the spatial streams associated with the corresponding RU. As described with reference to FIG. 2, each of the spatial streams associated with a given RU may have a same MCS. Additionally, the quantity of bits in a given sub-subset of bits may be proportional to a product of the modulation order of the MCS corresponding to the RU, the quantity of data subcarriers of the size of the RU, and the quantity of spatial streams for the user in this given RU, and the encoded bits may be parsed to each spatial stream via a round robin procedure. Additionally, each spatial stream may be associated with a respective constellation mapper. For instance, each constellation mapper may map the sub-subset of bits parsed to the associated spatial stream into a respective constellation size associated with the corresponding MCS for the associated RU. As such, each constellation mapper may be based on the type of modulation for the corresponding MCS (e.g., QAM, QPSK, BPSK, among other examples) of the RU. It is understood that each RU may be associated with any quantity of special streams corresponding to any quantity of constellation mappers.

Based on mapping the bits using the respective constellation mappers, the transmitter device 205 may perform tone mapping using respective tone mappers 420 (tone mapper 420-a, 420-b, 420-c, and 420-d) associated with RU size. In some examples, the transmitter device 205 may use a given tone mapper 420 to permute the stream of constellation points to obtain the corresponding spatial stream. While FIG. 4 illustrates the use LDPC tone mappers, it is understood that the techniques of FIG. 4 may use other forms of interleaving such as BCC interleavers, among other examples. Additionally, the tone mappers 420 may operate within each RU rather than within the MRU to separate given modulation schemes assigned to each RU of the MRU.

Based on performing tone mapping, the transmitter device 205 may perform a PSDU procedure 425. For example, the transmitter device 205 may apply a respective CSD to one or more of the spatial streams. A CSD may be used to apply a cyclic delay to each of the spatial streams to increase the channel frequency diversity and reduce correlation between the transmission on each spatial steam.

FIGS. 5A and 5B each show an example of a multi-RU configuration design 500-a and 500-b that supports signaling support for multiple coding schemes to a single user device spanning a frequency domain. In some examples, multi-RU configuration design 500-a and 500-b may implement or be implemented by aspects of wireless communication network 100, signaling diagram 200, and single PSDU encoding procedure 300 and 400. For example, multi-RU configuration design 500-a and 500-b may provide various configurations of multiple RUs 505 over a set of frequency carriers that span a frequency bandwidth. Additionally, the MCS configuration message 225 may indicate a given RU configuration via the set of bits included in the RU combination field, as described with reference to FIG. 2.

As illustrated in FIGS. 5A and 5B, two RUs 505 may span one or more frequency carrier sets 510 across a PPDU frequency bandwidth. In some examples, the PPDU bandwidth may satisfy a PPDU bandwidth threshold (e.g., greater than 80 MHz) and may support RU puncturing. In some examples, the quantity of RUs 505 (or MRUs) may be limited to two RUs 505, which may reduce MCS encoding and decoding complexity for non-AP STAs 104. In some examples, the RUs 505 may each satisfy an RU size threshold (e.g., greater than 20 MHz granularity or greater than 40 MHz granularity). Additionally, or alternatively, the two RUs 505 illustrated in FIGS. 5A and 5B may be examples of two RUs, one RU and one MRU, or two MRUs. In examples of MRUs, the multi-RU configuration design 500-a and 500-b may support non-OFDM MRUs and OFDMA MRUs.

As illustrated in FIG. 5A, the multi-RU configuration design 500-a may support two RUs 505 that may be interposed in frequency. For example, RU 505-a may span a first carrier set 510-a and a second carrier set 510-c. Additionally, RU 505-b may span at least a first carrier set 510-b which is greater in frequency compared to first carrier set 510-a and at a lower frequency than first carrier set 510-c. In some examples, the RU 505-b may include an additional frequency carrier set 510 that may be located at a frequency lower than frequency set 510-a or greater than frequency carrier 510-c.

In one example, of multi-RU configuration design 500-a, the RU 505-a and 505-b may divide a 160 MHz frequency bandwidth. For example, the RU 505-a may be an MRU where a first portion of the MRU (e.g., associated with frequency carrier set 510-a) may span 996 subcarriers and a second portion of the MRU (e.g., associated with frequency carrier set 510-c) may span 484 subcarriers (e.g., MRU996+484). Additionally, the RU 505-b may be an RU that spans 484 subcarriers (e.g., associated with frequency carrier set 510-b). As such, the example illustrated in FIG. 5A may be associated with a 160 MHz bandwidth with an RU combination of MRU996-[gap-484]-484 and RU484.

In some examples, each PPDU bandwidth may correspond with a respective set of unpunctured RU combinations for interposed RUs according to a multi-PSDU multi-RU transmission, as provided in Table 1:

TABLE 1

| PPDU | RU Combinations for Interposed RUs for Multi-RU |
|---|---|
| Bandwidth | Transmissions |
| 80 MHz | (RU484, RU484)x1 |
| 160 MHz | (RU484, RU996 + 484)x4, (RU996, RU996)x1 |
| 320 MHz | (RU484, RU3x996 + 484)x8, (RU996, RU3x996)x4, |
| | (RU996 + 484, RU2x996 + 484)x8, (RU2x996, |
| | RU2x996)x1 |

That is, Table 1 may indicate a respective set of unpunctured RU combinations that may be used for a given PPDU bandwidth (e.g., one RU combination for 80 MHz, five RU combinations for 160 MHz, and 21 RU combinations for 320 MHz) and with unequal MCS where an (M)RU split may cross 80 MHz frequency subblock. In some examples, each respective combination for a given PPDU bandwidth may correspond to a respective value included in the RU combination field of MCS configuration message 225. That is, if the AP and STA operate in accordance with a 160 MHz bandwidth for multi-PSDU transmissions, the RU combination field of MCS configuration message 225 may indicate one RU combination from the five possible RU combinations for the 160 MHz bandwidth. In Table 1, there may be one RU combination of certain sizes. For example, in an 80 MHz PPDU, there may be one RU combination of two RU484. There may be multiple RU combinations of various sizes. For example, in an 160 MHz PPDU, there are four RU combinations of an RU484 and an MRU 996+484, (e.g., the first RU484 and MRU [gap 484]-484-996, the second RU484 and MRU484-[gap 484]-996, the third RU484 and MRU996-[gap 484]-484 and the fourth RU484 and MRU996-484-[gap 484]. The actual RU combination may be jointly indicated by the RU combination indicated in the MCS configuration message 225 and the punctured channel information indicated in U-SIG. For example, if the punctured channel information indicates the first 40 MHz is punctured in a 320 MHz PPDU and the RU combination of (RU2x996, RU2x996) is indicated, the actual RU combination may be an MRU996+484 (e.g., MRU [gap 484]-996) in the lower 160 MHz and an RU2x996 in the upper 160 MHz.

In some examples, each PPDU bandwidth may correspond with a respective set of unpunctured RU combinations for interposed RUs according to a single-PSDU multi-RU transmission, as provided in Table 2:

TABLE 2

| PPDU | RU Combinations for Interposed RUs for Multi-RU |
|---|---|
| Bandwidth | Transmissions |
| 80 MHz | (RU484, RU484)x1 |
| 160 MHz | (RU996, RU996)x1 |
| 320 MHz | (RU996, RU3x996)x4, (RU2x996, RU2x996)x1 |

That is, Table 2 may indicate a respective set of unpunctured RU combinations that may be used for a given PPDU bandwidth (e.g., one RU combination for 80 MHz, one RU combination for 160 MHz, and 5 RU combinations for 320 MHz) and with unequal MCS, unequal modulation, or both, where (M)RU split may not cross 80 MHz frequency subblock. In some examples, each respective combination for a given PPDU bandwidth may correspond to a respective value included in the RU combination field of MCS configuration message 225. That is, if the AP and STA operate in accordance with a 320 MHz bandwidth for single-PSDU transmissions, the RU combination field of MCS configuration message 225 may indicate one RU combination from the five possible RU combinations for the 320 MHz bandwidth. In Table 2, there may be one RU combination of various sizes. For example, in an 80 MHz PPDU, there may be one RU combination of two RU484. There may be multiple RU combinations of certain sizes. For example, in a 320 MHz PPDU, there are four RU combinations of an RU996 and an MRU3x996, (e.g., the first RU996 and MRU[gap-996]-996-996, the second RU996 and MRU996-[gap 996]-996-996, the third RU996 and MRU996-996-[gap 996]-996 and the fourth RU996 and MRU996-996-996-[gap 996]. The actual RU combination may be jointly indicated by the RU combination indicated in the MCS configuration message 225 and the punctured channel information indicated in U-SIG. For example, if the punctured channel information indicates the first 40 MHz is punctured in a 320 MHz PPDU and the RU combination of (RU2x996, RU2x996) is indicated, the actual RU combination would be an MRU996+484 (e.g., MRU [gap 484]-996) in the lower 160 MHz and an RU2x996 in the upper 160 MHz.

As illustrated in FIG. 5B, the multi-RU configuration design 500-b may support two RUs 505 that may be non-interposed in frequency. For example, RU 505-c may span a first carrier set 510-d and a second carrier set 510-e. Additionally, RU 505-d may span at least a first carrier set 510-f which is greater in frequency compared to first carrier set 510-e. In some examples, the frequency carrier set 510-f may be lower in frequency compared to the frequency carrier set 510-d.

In one example, of multi-RU configuration design 500-b, the RU 505-c and 505-d may divide a 160 MHz frequency bandwidth. For example, the RU 505-c may be an MRU where a first portion of the MRU (e.g., associated with frequency carrier set 510-d) may span 996 subcarriers and a second portion of the MRU (e.g., associated with frequency carrier set 510-e) may span 484 subcarriers (e.g., MRU996+484). Additionally, the RU 505-d may be an RU that spans 484 subcarriers (e.g., associated with frequency carrier set 510-f). As such, the example illustrated in FIG. 5B may be associated with a 160 MHz bandwidth associated with the an RU combination of MRU996-484 and RU484, that are non-interposed.

In some examples, the each PPDU bandwidth may correspond with a respective set of unpunctured RU combinations for non-interposed RUs according to a multi-PSDU multi-RU transmission, as provided in Table 3:

TABLE 3

| PPDU | RU Combinations for Non-Interposed RUs for Multi- |
|---|---|
| Bandwidth | RU Transmissions |
| 80 MHz | (RU484, RU484)x1 |
| 160 MHz | (RU484, RU996 + 484)x2, (RU996, RU996)x1 |
| 320 MHz | (RU484, RU3x996 + 484)x2, (RU996, RU3x996)x2, |
| | (RU996 + 484, RU2x996 + 484)x2, (RU2x996, |
| | RU2x996)x1 |

That is Table 3 may indicate a respective set of unpunctured RU combinations that may be used for a given PPDU bandwidth (e.g., one RU combination for 80 MHz, three RU combinations for 160 MHz, and seven RU combinations for 320 MHz) and with unequal MCS where an (M)RU split may cross 80 MHz frequency subblock. In some examples, each respective combination for a given PPDU bandwidth may correspond to a respective value included in the RU combination field of MCS configuration message 225. That is, if the AP and STA operate in accordance with a 160 MHz bandwidth for multi-PSDU transmissions, the RU combination field of MCS configuration message 225 may indicate one RU combination from the three possible RU combinations for the 160 MHz bandwidth. In Table 3, there may be one RU combination of certain sizes. For example, in an 80 MHz PPDU, there is only one RU combinations of two RU484. There may be multiple RU combinations of certain sizes. For example, in an 160 MHz PPDU, there are two RU combinations of an RU484 and an MRU 996+484, (e.g., the first RU484 and MRU [gap 484]-484-996, and the fourth RU484 and MRU996-484-[gap 484]). The actual RU combination may be jointly indicated by the RU combination indicated in the MCS configuration message 225 and the punctured channel information indicated in U-SIG. For example, if the punctured channel information indicates the first 40 MHz is punctured in a 320 MHz PPDU and the RU combination of (RU2x996, RU2x996) is indicated, the actual RU combination may be an MRU996+484 (e.g., MRU [gap 484]-996) in the lower 160 MHz and an RU2x996 in the upper 160 MHz.

In some examples, each PPDU bandwidth may correspond with a respective set of unpunctured RU combinations for non-interposed RUs according to a single-PSDU multi-RU transmission, as provided in Table 4:

TABLE 4

| PPDU | RU Combinations for Non-Interposed RUs for Multi-RU |
|---|---|
| Bandwidth | Transmissions |
| 80 MHz | (RU484, RU484)x1 |
| 160 MHz | (RU996, RU996)x1 |
| 320 MHz | (RU996, RU3x996)x2, (RU2x996, RU2x996)x1 |

That is Table 4 may indicate a respective set of unpunctured RU combinations that may be used for a given PPDU bandwidth (e.g., one RU combination for 80 MHz, one RU combination for 160 MHz, and three RU combinations for 320 MHz) and with unequal MCS, unequal modulation, or both, where (M)RU split may not cross 80 MHz frequency subblock. In some examples, each respective combination for a given PPDU bandwidth may correspond to a respective value included in the RU combination field of MCS configuration message 225. That is, if the AP and STA operate in accordance with a 320 MHz bandwidth for single-PSDU transmissions, the RU combination field of MCS configuration message 225 may indicate one RU combination from the three possible RU combinations for the 320 MHz bandwidth. In Table 4, there may be one RU combination of certain sizes. For example, in an 80 MHz PPDU, there may be one RU combinations of two RU484. There may be multiple RU combinations of certain sizes. For example, in a 320 MHz PPDU, there are two RU combinations of an RU996 and an MRU3x996, (e.g., the first RU996 and MRU [gap 996]-996-996-996, and the fourth RU996 and MRU996-996-996-[gap 996]). The actual RU combination may be jointly indicated by the RU combination indicated in the MCS configuration message 225 and the punctured channel information indicated in U-SIG. For example, if the punctured channel information indicates the first 40 MHz is punctured in a 320 MHz PPDU and the RU combination of (RU2x996, RU2x996) is indicated, the actual RU combination would be an MRU996+484 (i.e., MRU [gap 484]-996) in the lower 160 MHz and an RU2x996 in the upper 160 MHz.

In some examples, the RU combination may be associated with a minimum RU size of RU484 (e.g., 40 MHz) and a fixed (e.g., static) way of splitting non-interposed RUs. In such examples, the RU combination may be split across direct current (DC) of the PPDU or the middle of the RU or MRU. If the RU combination split is static, then the AP 102 may refrain from signaling the RU combination. An example of a split and static unpunctured RU combination for different PPDU bandwidths is provided in Table 5:

TABLE 5

| PPDU | Split and Static RU Combinations for Non-Interposed |
|---|---|
| Bandwidth | RUs for Multi-RU Transmissions |
| 80 MHz | (RU484, RU484)x1 |
| 160 MHz | (RU996, RU996)x1 |
| 320 MHz | (RU2x996, RU2x996)x1 |

That is Table 5 may indicate a respective unpunctured RU combinations that may be used for a given PPDU bandwidth (e.g., one RU combination for 80 MHz, one RU combination for 160 MHz, and one RU combinations for 320 MHz) and with unequal MCS, unequal modulation, or both, where (M)RU split may not cross 80 MHz frequency subblock. In some examples, due to the static way of RU combination splitting, no signaling may be needed to indicate the specific RU combination, and an RU combination field may not exist in the MCS configuration message 225. The actual RU combination may be only determined by the punctured channel information indicated in U-SIG. For example, if the punctured channel information indicates the first 40 MHz is punctured in a 320 MHz PPDU, which may imply the unpunctured RU combination of (RU2x996, RU2x996), the actual RU combination would be an MRU996+484 (i.e., MRU [gap 484]-996) in the lower 160 MHz and an RU2x996 in the upper 160 MHz. In some examples, due to the static way of RU combination splitting, interposed RU or MRU may not be supported.

In some examples, if the PPDU bandwidth is 80 MHz, another way is to split into lower and upper half RU996 (e.g., each portion having 490 data tones and 8 pilot tones, where each portion is not a defined RU or MRU).

In some examples, an alternative to an interposed RU combination may be to split into greater than 2 RUs or MRUs. For example, split 320 MHz into four RU996 (e.g., the first, second, and fourth RU may use a first MCS or QAM while the third RU996 may use a different MCS or QAM).

In some examples, the actual RU combination may be derived from the unpunctured RU combination indication (e.g., explicit indication of Tables 1-4, or the static way of split as implied by Table 5) and the punctured channel indication through the punctured channel information subfield in U-SIG. For example, if the punctured channel information indicates the first 40 MHz is punctured in a 320 MHz PPDU and the unpunctured RU combination of (RU2x996, RU2x996) is indicated or implied, the actual RU combination may be an MRU996+484 (e.g., MRU [gap 484]-996) in the lower 160 MHz (with the first 40 MHz punctured) and an RU2x996 in the upper 160 MHz.

In some examples, the punctured channel information and RU combination may be jointly indicated in the punctured channel information subfield (e.g., of MCS configuration message 225).

In some examples, and RU may be split into portions (e.g., rather than defined as separate RUs or MRUs). For example, if the PPDU bandwidth is 80 MHz, a single RU may be split into lower and upper half RU996 (e.g., each having 490 data tones and 8 pilot tones). In such examples, the RU portions may include an intra-RU (or called inter-portion) parser to proportionally divide coded bits or QAM symbols into the different RU portions. Additionally, or alternatively, the AP 102 may have one LDPC tone mapper for each portion (e.g., the LDPC tone mapper for DCM if each portion is half a single RU).

In accordance with a single user transmission mode, if the PPDU Type and Compression Mode field (e.g., of MCS configuration message 225) is set to 1, the EHT MU PPDU is an EHT single user transmission or an EHT sounding NDP (regardless of the value of the UL/DL field). In addition to the PPDU Type and Compression Mode field being set to 1, if the EHT-SIG MCS field is set to 0 and the quantity of EHT-SIG symbols field is set to 0, it indicates an EHT sounding NDP. In the case of the EHT SU transmission, the quantity of EHT-SIG symbols field may be set to 0 if the EHT-SIG MCS field is set to 1 or 2 (e.g., 1 if the EHT-SIG MCS field is set to 0, or 3 if the EHT-SIG MCS field is set to 3). That is, the single user transmission indication is in U-SIG and may be independent of EHT-SIG or UHR-SIG.

In the EHT-SIG common field of an EHT single user transmission and non-OFDMA transmission to multiple users, there may be a total of 9 bits (e.g., reduce “Spatial Reuse” subfield from 4 to 2 bits by removing 12 reserved states, repurpose 4 disregard bits, and repurpose 3 bits in the “Number of Non-OFDMA Users” subfield) available for other signaling, in the single user transmission mode. As such, these bits in UHR-SIG may be used for 1 more bit in the user field, the “RU combination” subfield (if not included in the punctured channel information subfield) for unequal MCS or unequal modulation, and the “MCS pattern” field for unequal MCS across RUs or MRUs or “unequal modulation pattern” field for unequal modulation pattern across RUs or MRSs (e.g., using 3 bits).

In some cases, if the PPDU bandwidth is divided into more than 2 RUs, MRUs, or portions (e.g., splitting 320 MHz into four RU996) there may be multiple subfields within the “unequal MCS pattern” field for unequal MCS or the “unequal modulation pattern” field for unequal modulation. For instance, each subfield may correspond to one RU or MRU component or portion (e.g., relative to the anchor RU, MRU, or portion). In such cases, the 2-bit or 3-bit implementations of the “pattern” fields (e.g., using 3 bits to indicate MCS−3, MCS−2, MCS−1, MCS, MCS+1, MCS+2, MCS+3, as MCS (or data rate) relative to the MCS of the anchor RU, MRU or portion) may be used for each such subfield. Additionally, or alternatively, one “pattern” field may jointly indicate the patterns for each of the RU or MRU components or portions (e.g., other than the anchor MRU, RU, or portion).

In some examples of the single user transmission mode, the punctured channel information and actual RU combination may be jointly indicated in the punctured channel information subfield in U-SIG. For example, the punctured channel information subfield may be 5 or 6 or 7 bits to indicate up to 32 or 64 or 128 punctured patterns and RU or MRU combinations (or combinations of portions).

In some cases, the bits of the punctured channel information subfield may correspond to Table 6 (e.g., for 40 MHz and 80 MHz PPDU bandwidth):

TABLE 6

| | | | | RU or MRU Combination | |
|---|---|---|---|---|---|
| PPDU | | Puncturing pattern | | Lower RU or | Upper RU or |
| bandwidth | Cases | (RU or MRU Index) | Field value | MRU | MRU |
| 40 MHz | No puncturing | [1 1] | 0 | [1 x] | [x 1] |
| | | (484-tone RU 1) | | 242-tone RU1 | 242-tone RU2 |
| 80 MHz | No puncturing | [1 1 1 1] | 0 | [1 1 x x] | [x x 1 1] |
| | | (996-tone RU 1) | | 484-tone RU 1 | 484-tone RU 2 |
| | 20 MHz | [x 1 1 1] | 1 | [x 1 x x] | [x x 1 1] |
| | puncturing | (484 + 242-tone MRU | | 242-tone RU 2 | 484-tone RU 2 |
| | | 1) | | | |
| | | [1 x 1 1] | 2 | [1 x x x] | [x x 1 1] |
| | | (484 + 242-tone MRU | | 242-tone RU 1 | 484-tone RU 2 |
| | | 2) | | | |
| | | [1 1 x 1] | 3 | [1 1 x x] | [x x x 1] |
| | | (484 + 242-tone MRU | | 484-tone RU 1 | 242-tone RU 4 |
| | | 3) | | | |
| | | [1 1 1 x] | 4 | [1 1 x x] | [x x 1 x] |
| | | (484 + 242-tone MRU | | 484-tone RU 1 | 242-tone RU 3 |
| | | 4) | | | |
| | No puncturing | [1 1 1 1] | 5 | [1 x x x] | [x 1 1 1] |
| | | (996-tone RU 1) | | 242-tone RU 1 | 484 + 242-tone |
| | | | | | MRU 1 |
| | | [1 1 1 1] | 6 | [1 x 1 1] | [x 1 x x] |
| | | (996-tone RU 1) | | 484 + 242-tone | 242-tone RU 2 |
| | | | | MRU 2 | |
| | | [1 1 1 1] | 7 | [1 1 x 1] | [x x 1 x] |
| | | (996-tone RU 1) | | 484 + 242-tone | 242-tone RU 3 |
| | | | | MRU 3 | |
| | | [1 1 1 1] | 8 | [1 1 1 x] | [x x x 1] |
| | | (996-tone RU 1) | | 484 + 242-tone | 242-tone RU 4 |
| | | | | MRU 4 | |

In Table 6, “1” denotes a nonpunctured subchannel and an “x” denotes a punctured subchannel. The puncturing granularity for 40 MHz and 80 MHz PPDU bandwidth is 20 MHz. In accordance with the 40 MHz PPDU bandwidth of Table 6, in the cases of static split of the unpunctured bandwidth, there may be one entry (e.g., field value 0). In accordance with the 80 MHz PPDU bandwidth of Table 6, in cases of both punctured and unpunctured bandwidth, assuming static split of the unpunctured case, there may be five entries (e.g., field value 0, 1, 2, 3, 4). In accordance with the 80 MHz PPDU bandwidth of Table 6, assuming dynamic split of the unpunctured case and support 4 RU and MRU combinations of (RU242, MRU484+242), there may be four more entries (e.g., field value 5, 6, 7, and 8). That is, five bits in the punctured channel information subfield may be used for operations in accordance with Table 6. Note that the dynamic split of the unpunctured cases into the RU and MRU combination of (RU242, MRU484+242) (e.g., field value 5, 6, 7, and 8) does not have split across 80 MHz frequency subblocks.

In some cases, the bits of the punctured channel information subfield may correspond to Table 7 (e.g., for 160 MHz PPDU bandwidth):

TABLE 7

| | | | | RU or MRU Combination | |
|---|---|---|---|---|---|
| PPDU | | Puncturing pattern (RU | Field | | Upper RU or |
| Bandwidth | Cases | or MRU Index) | value | Lower RU or MRU | MRU |
| 160 MHz | No puncturing | [1 1 1 1 1 1 1 1] | 0 | [1 1 1 1 x x x x] | [x x x x 1 1 1 1] |
| | | (2x996-tone RU 1) | | 996-tone RU 1 | 996-tone RU 2 |
| | 20 MHz | [x 1 1 1 1 1 1 1] | 1 | [x 1 1 1 x x x x] | [x x x x 1 1 1 1] |
| | puncturing | (996 + 484 + 242-tone MRU | | 484 + 242-tone MRU 1 | 996-tone RU 2 |
| | | 1) | | | |
| | | [1 x 1 1 1 1 1 1] | 2 | [1 x 1 1 x x x x] | [x x x x 1 1 1 1] |
| | | (996 + 484 + 242-tone MRU | | 484 + 242-tone MRU 2 | 996-tone RU 2 |
| | | 2) | | | |
| | | [1 1 x 1 1 1 1 1] | 3 | [1 1 x 1 x x x x] | [x x x x 1 1 1 1] |
| | | (996 + 484 + 242-tone MRU | | 484 + 242-tone MRU 3 | 996-tone RU 2 |
| | | 3) | | | |
| | | [1 1 1 x 1 1 1 1] | 4 | [1 1 1 x x x x x] | [x x x x 1 1 1 1] |
| | | (996 + 484 + 242-tone MRU | | 484 + 242-tone MRU 4 | 996-tone RU 2 |
| | | 4) | | | |
| | | [1 1 1 1 x 1 1 1] | 5 | [1 1 1 1 x x x x] | [x x x x x 1 1 1] |
| | | (996 + 484 + 242-tone MRU | | 996-tone RU 1 | 484 + 242-tone |
| | | 5) | | | MRU 5 |
| | | [1 1 1 1 1 x 1 1] | 6 | [1 1 1 1 x x x x] | [x x x x 1 x 1 1] |
| | | (996 + 484 + 242-tone MRU | | 996-tone RU 1 | 484 + 242-tone |
| | | 6) | | | MRU 6 |
| | | [1 1 1 1 1 1 x 1] | 7 | [1 1 1 1 x x x x] | [x x x x 1 1 x 1] |
| | | (996 + 484 + 242-tone MRU | | 996-tone RU 1 | 484 + 242-tone |
| | | 7) | | | MRU 7 |
| | | [1 1 1 1 1 1 1 x] | 8 | [1 1 1 1 x x x x] | [x x x x 1 1 1 x] |
| | | (996 + 484 + 242-tone MRU | | 996-tone RU 1 | 484 + 242-tone |
| | | 8) | | | MRU 8 |
| | 40 MHz | [x x 1 1 1 1 1 1] | 9 | [x x 1 1 x x x x] | [x x x x 1 1 1 1] |
| | puncturing | (996 + 484-tone MRU 1) | | 484-tone RU 2 | 996-tone RU 2 |
| | | [1 1 x x 1 1 1 1] | 10 | [1 1 x x x x x x] | [x x x x 1 1 1 1] |
| | | (996 + 484-tone MRU 2) | | 484-tone RU 1 | 996-tone RU 2 |
| | | [1 1 1 1 x x 1 1] | 11 | [1 1 1 1 x x x x] | [x x x x x x 1 1] |
| | | (996 + 484-tone MRU 3) | | 996-tone RU 1 | 484-tone RU 4 |
| | | [1 1 1 1 1 1 x x] | 12 | [1 1 1 1 x x x x] | [x x x x 1 1 x x] |
| | | (996 + 484-tone MRU 4) | | 996-tone RU 1 | 484-tone RU 3 |
| | No puncturing | [1 1 1 1 1 1 1 1] | 13 | [1 1 x x x x x x] | [x x 1 1 1 1 1 1] |
| | | (2x996-tone RU 1) | | 484-tone RU 1 | (996 + 484-tone |
| | | | | | MRU 1) |
| | | [1 1 1 1 1 1 1 1] | 14 | [1 1 x x 1 1 1 1] | [x x 1 1 x x x x] |
| | | (2x996-tone RU 1) | | (996 + 484-tone MRU 2) | 484-tone RU 2 |
| | | [1 1 1 1 1 1 1 1] | 15 | [1 1 1 1 x x 1 1] | [x x x x 1 1 x x] |
| | | (2x996-tone RU 1) | | (996 + 484-tone MRU 3) | 484-tone RU 3 |
| | | [1 1 1 1 1 1 1 1] | 16 | [1 1 1 1 1 1 x x] | [x x x x x x 1 1] |
| | | (2x996-tone RU 1) | | (996 + 484-tone MRU 4) | 484-tone RU 4 |

In Table 7, “1” denotes a nonpunctured subchannel and an “x” denotes a punctured subchannel. The puncturing granularity for 160 MHz PPDU bandwidth is 20 MHz. In accordance with the 160 MHz PPDU bandwidth of Table 7, if static split of the unpunctured case is assumed, the punctured channel information subfield may indicate one of 13 possible entries (e.g., corresponding to field value 0-12, respectively). If dynamic split of the unpunctured case is assumed which supports 4 RU and MRU combinations of (RU484, MRU996+484), the punctured channel information subfield may additionally indicate one of 17 entries (e.g., corresponding to field value 0-16, respectively). That is, five bits in the punctured channel information subfield may be used for operations in accordance with Table 7. Note that the dynamic split of the unpunctured cases into the RU and MRU combination of (RU484, MRU996+484) (e.g., corresponding to field value 13-16) may have split across 80 MHz frequency subblocks.

In some cases, the bits of the punctured channel information subfield may correspond to Tables 8, 9, 10, 11, and 12 (e.g., for 320 MHz PPDU bandwidth):

TABLE 8

| PPDU | | Puncturing pattern (RU | Field | RU or MRU Combination | |
|---|---|---|---|---|---|
| Bandwidth | Cases | or MRU Index) | value | Lower RU or MRU | Upper RU or MRU |
| 320 MHz | No puncturing | [1 1 1 1 1 1 1 1] | 0 | [1 1 1 1 x x x x] | [x x x x 1 1 1 1] |
| | | (4x996-tone RU 1) | | 2x996-tone RU 1 | 2x996-tone RU 2 |
| | 40 MHz | [x 1 1 1 1 1 1 1] | 1 | [x 1 1 1 x x x x] | [x x x x 1 1 1 1] |
| | puncturing | (3x996 + 484-tone MRU | | 996 + 484-tone MRU | 2x996-tone RU 2 |
| | | 1) | | 1 | |
| | | [1 x 1 1 1 1 1 1] | 2 | [1 x 1 1 x x x x] | [x x x x 1 1 1 1] |
| | | (3x996 + 484-tone MRU | | 996 + 484-tone MRU | 2x996-tone RU 2 |
| | | 2) | | 2 | |
| | | [1 1 x 1 1 1 1 1] | 3 | [1 1 x 1 x x x x] | [x x x x 1 1 1 1] |
| | | (3x996 + 484-tone MRU | | 996 + 484-tone MRU | 2x996-tone RU 2 |
| | | 3) | | 3 | |
| | | [1 1 1 x 1 1 1 1] | 4 | [1 1 1 x x x x x] | [x x x x 1 1 1 1] |
| | | (3x996 + 484-tone MRU | | 996 + 484-tone MRU | 2x996-tone RU 2 |
| | | 4) | | 4 | |
| | | [1 1 1 1 x 1 1 1] | 5 | [1 1 1 1 x x x x] | [x x x x x 1 1 1] |
| | | (3x996 + 484-tone MRU | | 2x996-tone RU 1 | 996 + 484-tone MRU |
| | | 5) | | | 5 |
| | | [1 1 1 1 1 x 1 1] | 6 | [1 1 1 1 x x x x] | [x x x x 1 x 1 1] |
| | | (3x996 + 484-tone MRU | | 2x996-tone RU 1 | 996 + 484-tone MRU |
| | | 6) | | | 6 |
| | | [1 1 1 1 1 1 x 1] | 7 | [1 1 1 1 x x x x] | [x x x x 1 1 x 1] |
| | | (3x996 + 484-tone MRU | | 2x996-tone RU 1 | 996 + 484-tone MRU |
| | | 7) | | | 7 |
| | | [1 1 1 1 1 1 1 x] | 8 | [1 1 1 1 x x x x] | [x x x x 1 1 1 x] |
| | | (3x996 + 484-tone MRU | | 2x996-tone RU 1 | 996 + 484-tone MRU |
| | | 8) | | | 8 |
| | 80 MHz | [x x 1 1 1 1 1 1] | 9 | [x x 1 1 x x x x] | [x x x x 1 1 1 1] |
| | puncturing | (3x996-tone MRU 1) | | 996-tone RU 2 | 2x996-tone RU 2 |
| | | [1 1 x x 1 1 1 1] | 10 | [1 1 x x x x x x] | [x x x x 1 1 1 1] |
| | | (3x996-tone MRU 2) | | 996-tone RU 1 | 2x996-tone RU 2 |
| | | [1 1 1 1 x x 1 1] | 11 | [1 1 1 1 x x x x] | [x x x x x x 1 1] |
| | | (3x996-tone MRU 3) | | 2x996-tone RU 1 | 996-tone RU 4 |
| | | [1 1 1 1 1 1 x x] | 12 | [1 1 1 1 x x x x] | [x x x x 1 1 x x] |
| | | (3x996-tone MRU 4) | | 2x996-tone RU 1 | 996-tone RU 3 |

TABLE 9

| PPDU | | Puncturing pattern (RU | Field | RU or MRU Combination | |
|---|---|---|---|---|---|
| Bandwidth | Cases | or MRU Index) | value | Lower RU or MRU | Upper RU or MRU |
| 320 MHz | Concurrent | [x x x 1 1 1 1 1] | 13 | [x x x 1 x x x x] | [x x x x 1 1 1 1] |
| | 80 MHz and | (2x996 + 484-tone MRU 7) | | 484-tone RU 4 | 2x996-tone RU 2 |
| | 40 MHz | [x x 1 x 1 1 1 1] | 14 | [x x 1 x x x x x] | [x x x x 1 1 1 1] |
| | puncturing | (2x996 + 484-tone MRU 8) | | 484-tone RU 3 | 2x996-tone RU 2 |
| | | [x x 1 1 x 1 1 1] | 15 | [x x 1 1 x x x x] | [x x x x x 1 1 1] |
| | | (2x996 + 484-tone MRU 9) | | 996-tone RU 2 | 996 + 484-tone MRU |
| | | | | | 5 |
| | | [x x 1 1 1 x 1 1] | 16 | [x x 1 1 x x x x] | [x x x x 1 x 1 1] |
| | | (2x996 + 484-tone MRU | | 996-tone RU 2 | 996 + 484-tone MRU |
| | | 10) | | | 6 |
| | | [x x 1 1 1 1 x 1] | 17 | [x x 1 1 x x x x] | [x x x x 1 1 x 1] |
| | | (2x996 + 484-tone MRU | | 996-tone RU 2 | 996 + 484-tone MRU |
| | | 11) | | | 7 |
| | | [x x 1 1 1 1 1 x] | 18 | [x x 1 1 x x x x] | [x x x x 1 1 1 x] |
| | | (2x996 + 484-tone MRU | | 996-tone RU 2 | 996 + 484-tone MRU |
| | | 12) | | | 8 |
| | | [x 1 1 1 1 1 x x] | 19 | [x 1 1 1 x x x x] | [x x x x 1 1 x x] |
| | | (2x996 + 484-tone MRU 1) | | 996 + 484-tone MRU | 996-tone RU 3 |
| | | | | 1 | |
| | | [1 x 1 1 1 1 x x] | 20 | [1 x 1 1 x x x x] | [x x x x 1 1 x x] |
| | | (2x996 + 484-tone MRU 2) | | 996 + 484-tone MRU | 996-tone RU 3 |
| | | | | 2 | |
| | | [1 1 x 1 1 1 x x] | 21 | [1 1 x 1 x x x x] | [x x x x 1 1 x x] |
| | | (2x996 + 484-tone MRU 3) | | 996 + 484-tone MRU | 996-tone RU 3 |
| | | | | 3 | |
| | | [1 1 1 x 1 1 x x] | 22 | [1 1 1 x x x x x] | [x x x x 1 1 x x] |
| | | (2x996 + 484-tone MRU 4) | | 996 + 484-tone MRU | 996-tone RU 3 |
| | | | | 4 | |
| | | [1 1 1 1 x 1 x x] | 23 | [1 1 1 1 x x x x] | [x x x x x 1 x x] |
| | | (2x996 + 484-tone MRU 5) | | 2x996-tone RU 1 | 484-tone RU 6 |
| | | [1 1 1 1 1 x x x] | 24 | [1 1 1 1 x x x x] | [x x x x 1 x x x] |
| | | (2x996 + 484-tone MRU 6) | | 2x996-tone RU 1 | 484-tone RU 5 |
| | No | [1 1 1 1 1 1 1 1] | 25 | [1 1 x x x x x x] | [x x 1 1 1 1 1 1] |
| | puncturing | (4x996-tone RU 1) | | 996-tone RU 1 | 3x996-tone MRU 1 |
| | | [1 1 1 1 1 1 1 1] | 26 | [1 1 x x 1 1 1 1] | [x x 1 1 x x x x] |
| | | (4x996-tone RU 1) | | 3x996-tone MRU 2 | 996-tone RU 2 |
| | | [1 1 1 1 1 1 1 1] | 27 | [1 1 1 1 x x 1 1] | [x x x x 1 1 x x] |
| | | (4x996-tone RU 1) | | 3x996-tone MRU 3 | 996-tone RU 3 |
| | | [1 1 1 1 1 1 1 1] | 28 | [1 1 1 1 1 1 x x] | [x x x x x x 1 1] |
| | | (4x996-tone RU 1) | | 3x996-tone MRU 4 | 996-tone RU 4 |

TABLE 10

| PPDU | | Puncturing pattern (RU | Field | RU or MRU Combination | |
|---|---|---|---|---|---|
| bandwidth | Cases | or MRU Index) | value | Lower RU or MRU | Upper RU or MRU |
| 320 MHz | No | [1 1 1 1 1 1 1 1] | 29 | [1 x x x x x x x] | [x 1 1 1 1 1 1 1] |
| | puncturing | (4x996-tone RU 1) | | 484-tone RU 1 | (3x996 + 484-tone |
| | | | | | MRU 1) |
| | | [1 1 1 1 1 1 1 1] | 30 | [1 x 1 1 1 1 1 1] | [x 1 x x x x x x] |
| | | (4x996-tone RU 1) | | (3x996 + 484-tone | 484-tone RU 2 |
| | | | | MRU 2) | |
| | | [1 1 1 1 1 1 1 1] | 31 | [1 1 x 1 1 1 1 1] | [x x 1 x x x x x] |
| | | (4x996-tone RU 1) | | (3x996 + 484-tone | 484-tone RU 3 |
| | | | | MRU 3) | |
| | | [1 1 1 1 1 1 1 1] | 32 | [1 1 1 x 1 1 1 1] | [x x x 1 x x x x] |
| | | (4x996-tone RU 1) | | (3x996 + 484-tone | 484-tone RU 4 |
| | | | | MRU 4) | |
| | | [1 1 1 1 1 1 1 1] | 33 | [1 1 1 1 x 1 1 1] | [x x x x 1 x x x] |
| | | (4x996-tone RU 1) | | (3x996 + 484-tone | 484-tone RU 5 |
| | | | | MRU 5) | |
| | | [1 1 1 1 1 1 1 1] | 34 | [1 1 1 1 1 x 1 1] | [x x x x x 1 x x] |
| | | (4x996-tone RU 1) | | (3x996 + 484-tone | 484-tone RU 6 |
| | | | | MRU 6) | |
| | | [1 1 1 1 1 1 1 1] | 35 | [1 1 1 1 1 1 x 1] | [x x x x x x 1 x] |
| | | (4x996-tone RU 1) | | (3x996 + 484-tone | 484-tone RU 7 |
| | | | | MRU 7) | |
| | | [1 1 1 1 1 1 1 1] | | [1 1 1 1 1 1 1 x] | [x x x x x x x 1] |
| | | (4x996-tone RU 1) | 36 | (3x996 + 484-tone | 484-tone RU 8 |
| | | | | MRU 8) | |
| | | [1 1 1 1 1 1 1 1] | 37 | [1 1 x 1 x x x x] | [x x 1 x 1 1 1 1] |
| | | (4x996-tone RU 1) | | 996 + 484-tone MRU 3 | (2x996 + 484-tone |
| | | | | | MRU 8) |
| | | [1 1 1 1 1 1 1 1] | 38 | [1 1 1 x x x x x] | [x x x 1 1 1 1 1] |
| | | (4x996-tone RU 1) | | 996 + 484-tone MRU 4 | (2x996 + 484-tone |
| | | | | | MRU 7) |
| | | [1 1 1 1 1 1 1 1] | 39 | [1 1 1 1 1 x x x] | [x x x x x 1 1 1] |
| | | (4x996-tone RU 1) | | (2x996 + 484-tone | 996 + 484-tone MRU |
| | | | | MRU 6) | 5 |
| | | [1 1 1 1 1 1 1 1] | 40 | [1 1 1 1 x 1 x x] | [x x x x 1 x 1 1] |
| | | (4x996-tone RU 1) | | (2x996 + 484-tone | 996 + 484-tone MRU |
| | | | | MRU 5) | 6 |
| | 40 MHz | [x 1 1 1 1 1 1 1] | 41 | [x 1 x x x x x x] | [x x 1 1 1 1 1 1] |
| | puncturing | (3x996 + 484-tone MRU 1) | | 484-tone RU 2 | 3x996-tone MRU 1 |
| | | [1 x 1 1 1 1 1 1] | 42 | [1 x x x x x x x] | [x x 1 1 1 1 1 1] |
| | | (3x996 + 484-tone MRU 2) | | 484-tone RU 1 | 3x996-tone MRU 1 |
| | | [1 1 x 1 1 1 1 1] | 43 | [1 1 x x 1 1 1 1] | [x x x 1 x x x x] |
| | | (3x996 + 484-tone MRU 3) | | 3x996-tone MRU 2 | 484-tone RU 4 |
| | | [1 1 1 x 1 1 1 1] | 44 | [1 1 x x 1 1 1 1] | [x x 1 x x x x x] |
| | | (3x996 + 484-tone MRU 4) | | 3x996-tone MRU 2 | 484-tone RU 3 |
| | | [1 1 1 1 x 1 1 1] | 45 | [1 1 1 1 x x 1 1] | [x x x x x 1 x x] |
| | | (3x996 + 484-tone MRU 5) | | 3x996-tone MRU 3 | 484-tone RU 6 |
| | | [1 1 1 1 1 x 1 1] | 46 | [1 1 1 1 x x 1 1] | [x x x x 1 x x x] |
| | | (3x996 + 484-tone MRU 6) | | 3x996-tone MRU 3 | 484-tone RU 5 |
| | | [1 1 1 1 1 1 x 1] | 47 | [1 1 1 1 1 1 x x] | [x x x x x x x 1] |
| | | (3x996 + 484-tone MRU 7) | | 3x996-tone MRU 4 | 484-tone RU 8 |
| | | [1 1 1 1 1 1 1 x] | 48 | [1 1 1 1 1 1 x x] | [x x x x x x 1 x] |
| | | (3x996 + 484-tone MRU 8) | | 3x996-tone MRU 4 | 484-tone RU 7 |

TABLE 11

| | | | | RU or MRU Combination | |
|---|---|---|---|---|---|
| PPDU | | Puncturing pattern (RU | Field | Lower RU or | |
| Bandwidth | Cases | or MRU Index) | value | MRU | Upper RU or MRU |
| 320 MHz | 40 MHz | [x 1 1 1 1 1 1 1] | 49 | [x 1 1 1 1 1 x x] | [x x x x x x 1 1] |
| | puncturing | (3x996 + 484-tone MRU | | (2x996 + 484-tone | 996-tone RU 4 |
| | | 1) | | MRU 1) | |
| | | [1 x 1 1 1 1 1 1] | 50 | [1 x 1 1 1 1 x x] | [x x x x x x 1 1] |
| | | (3x996 + 484-tone MRU | | (2x996 + 484-tone | 996-tone RU 4 |
| | | 2) | | MRU 2) | |
| | | [1 1 x 1 1 1 1 1] | 51 | [1 1 x 1 1 1 x x] | [x x x x x x 1 1] |
| | | (3x996 + 484-tone MRU | | (2x996 + 484-tone | 996-tone RU 4 |
| | | 3) | | MRU 3) | |
| | | [1 1 x 1 1 1 1 1] | 52 | [1 1 x x x x x x] | [x x x 1 1 1 1 1] |
| | | (3x996 + 484-tone MRU | | 996-tone RU 1 | (2x996 + 484-tone |
| | | 3) | | | MRU 7) |
| | | [1 1 1 x 1 1 1 1] | 53 | [1 1 1 x 1 1 x x] | [x x x x x x 1 1] |
| | | (3x996 + 484-tone MRU | | (2x996 + 484-tone | 996-tone RU 4 |
| | | 4) | | MRU 4) | |
| | | [1 1 1 x 1 1 1 1] | 54 | [1 1 x x x x x x] | [x x 1 x 1 1 1 1] |
| | | (3x996 + 484-tone MRU | | 996-tone RU 1 | (2x996 + 484-tone |
| | | 4) | | | MRU 8) |
| | | [1 1 1 1 x 1 1 1] | 55 | [1 1 1 1 x 1 x x] | [x x x x x x 1 1] |
| | | (3x996 + 484-tone MRU | | (2x996 + 484-tone | 996-tone RU 4 |
| | | 5) | | MRU 5) | |
| | | [1 1 1 1 x 1 1 1] | 56 | [1 1 x x x x x x] | [x x 1 1 x 1 1 1] |
| | | (3x996 + 484-tone MRU | | 996-tone RU 1 | (2x996 + 484-tone |
| | | 5) | | | MRU 9) |
| | | [1 1 1 1 1 x 1 1] | 57 | [1 1 1 1 1 x x x] | [x x x x x x 1 1] |
| | | (3x996 + 484-tone MRU | | (2x996 + 484-tone | 996-tone RU 4 |
| | | 6) | | MRU 6) | |
| | | [1 1 1 1 1 x 1 1] | 58 | [1 1 x x x x x x] | [x x 1 1 1 x 1 1] |
| | | (3x996 + 484-tone MRU | | 996-tone RU 1 | (2x996 + 484-tone |
| | | 6) | | | MRU 10) |
| | | [1 1 1 1 1 1 x 1] | 59 | [1 1 x x x x x x] | [x x 1 1 1 1 x 1] |
| | | (3x996 + 484-tone MRU | | 996-tone RU 1 | (2x996 + 484-tone |
| | | 7) | | | MRU 11) |
| | | [1 1 1 1 1 1 1 x] | 60 | [1 1 x x x x x x] | [x x 1 1 1 1 1 x] |
| | | (3x996 + 484-tone MRU | | 996-tone RU 1 | (2x996 + 484-tone |
| | | 8) | | | MRU 12) |

TABLE 12

| PPDU | | Puncturing pattern (RU | Field | RU or MRU Combination | |
|---|---|---|---|---|---|
| Bandwidth | Cases | or MRU Index) | value | Lower RU or MRU | Upper RU or MRU |
| 320 MHz | 80 MHz | [x x 1 1 1 1 1 1] | 61 | [x x 1 x x x x x] | [x x x 1 1 1 1 1] |
| | puncturing | (3x996-tone MRU 1) | | 484-tone RU 3 | (2x996 + 484-tone |
| | | | | | MRU 7) |
| | | [x x 1 1 1 1 1 1] | 62 | [x x 1 x 1 1 1 1] | [x x x 1 x x x x] |
| | | (3x996-tone MRU 1) | | (2x996 + 484-tone | 484-tone RU 4 |
| | | | | MRU 8) | |
| | | [x x 1 1 1 1 1 1] | 63 | [x x 1 1 x 1 1 1] | [x x x x 1 x x x] |
| | | (3x996-tone MRU 1) | | (2x996 + 484-tone | 484-tone RU 5 |
| | | | | MRU 9) | |
| | | [x x 1 1 1 1 1 1] | 64 | [x x 1 1 1 x 1 1] | [x x x x x 1 x x] |
| | | (3x996-tone MRU 1) | | (2x996 + 484-tone | 484-tone RU 6 |
| | | | | MRU 10) | |
| | | [x x 1 1 1 1 1 1] | 65 | [x x 1 1 1 1 x 1] | [x x x x x x 1 x] |
| | | (3x996-tone MRU 1) | | (2x996 + 484-tone | 484-tone RU 7 |
| | | | | MRU 11) | |
| | | [x x 1 1 1 1 1 1] | 66 | [x x 1 1 1 1 1 x] | [x x x x x x x 1] |
| | | (3x996-tone MRU 1) | | (2x996 + 484-tone | 484-tone RU 8 |
| | | | | MRU 12) | |
| | | [1 1 1 1 1 1 x x] | 67 | [1 x x x x x x x] | [x 1 1 1 1 1 x x] |
| | | (3x996-tone MRU 4) | | 484-tone RU 1 | (2x996 + 484-tone |
| | | | | | MRU 1) |
| | | [1 1 1 1 1 1 x x] | 68 | [1 x 1 1 1 1 x x] | [x 1 x x x x x x] |
| | | (3x996-tone MRU 4) | | (2x996 + 484-tone | 484-tone RU 2 |
| | | | | MRU 2) | |
| | | [1 1 1 1 1 1 x x] | 69 | [1 1 x 1 1 1 x x] | [x x 1 x x x x x] |
| | | (3x996-tone MRU 4) | | (2x996 + 484-tone | 484-tone RU 3 |
| | | | | MRU 3) | |
| | | [1 1 1 1 1 1 x x] | 70 | [1 1 1 x 1 1 x x] | [x x x 1 x x x x] |
| | | (3x996-tone MRU 4) | | (2x996 + 484-tone | 484-tone RU 4 |
| | | | | MRU 4) | |
| | | [1 1 1 1 1 1 x x] | 71 | [1 1 1 1 x 1 x x] | [x x x x 1 x x x] |
| | | (3x996-tone MRU 4) | | (2x996 + 484-tone | 484-tone RU 5 |
| | | | | MRU 5) | |
| | | [1 1 1 1 1 1 x x] | 72 | [1 1 1 1 1 x x x] | [x x x x x 1 x x] |
| | | (3x996-tone MRU 4) | | (2x996 + 484-tone | 484-tone RU 6 |
| | | | | MRU 6) | |

In Tables 8-12, “1” denotes a nonpunctured subchannel and an “x” denotes a punctured subchannel. The puncturing granularity for 320 MHz PPDU bandwidth is 40 MHz. In accordance with the 320 MHz PPDU bandwidth of Tables 8, 9, 10, 11, and 12 if static split of the unpunctured case is assumed, the punctured channel information subfield may indicate one of 25 possible entries (e.g., corresponding to field value 0-24, respectively). If dynamic split of the unpunctured case may be assumed which supports 4 RU and MRU combinations of (RU996, MRU3x996), the punctured channel information subfield may indicate one of 29 possible entries (e.g., corresponding to field value 0-28, respectively). That is, five bits in the punctured channel information subfield may be used for operations in accordance with Tables 8, 9, 10, 11, and 12. Note that the dynamic split of the unpunctured cases into the RU and MRU combination of (RU996, MRU3x996) (e.g., corresponding to field value 25-28) does not have split across 80 MHz frequency subblocks.

Additionally, or alternatively, if dynamic split may be assumed which supports 4 RU and MRU combinations of (RU996, MRU3x996), 8 RU and MRU combinations of (RU484, MRU3x996+484) and 4 RU and MRU combinations of (MRU996+484, MRU2x996+484) for the unpunctured case, and 8 RU and MRU combinations of (RU484, MRU3x996) for the 40 MHz puncturing case, the punctured channel information subfield may indicate one of 49 possible entries (e.g., corresponding to field value 0-48, respectively). That is, six bits in the punctured channel information subfield may be used for operations in accordance with Tables 8, 9, 10, 11, and 12. Note that the dynamic split of the unpunctured cases into the RU and MRU combination of (RU484, MRU3x996+484) (e.g., corresponding to field value 29-40) have split across 80 MHz frequency subblocks. But the dynamic split of the unpunctured cases into the RU and MRU combination of (RU996, MRU3x996) (e.g., corresponding to field value 25-28) and the dynamic split of the 40 MHz puncturing cases into the RU and MRU combination of (RU484, MRU3x996) (e.g., corresponding to field value 41-48) does not have split across 80 MHz frequency subblocks.

Additionally or alternatively, if dynamic split supports 4 RU and MRU combinations of (RU996, MRU3x996), 8 RU and MRU combinations of (RU484, MRU3x996+484) and 4 RU and MRU combinations of (MRU996+484, MRU2x996+484) for the unpunctured case, 8 RU and MRU combinations of (RU484, MRU3x996) and 12 RU and MRU combinations of (RU996, MRU2x996+484) for the 40 MHz puncturing case, and 12 RU and MRU combinations of (RU484, MRU2x996+484) for the 80 MHz puncturing case, then the punctured channel information subfield may indicate an additional 48 entries (e.g., corresponding to field value 25-72). That is, seven bits in the punctured channel information subfield may be used for operations in accordance with Tables 8, 9, 10, 11, and 12. Note that the dynamic split of the unpunctured cases into the RU and MRU combination of (RU484, MRU3x996+484) (e.g., corresponding to field value 29-40) and the dynamic split of the 80 MHz puncturing cases into the RU and MRU combination of (RU484, MRU2x996+484) (e.g., corresponding to field values 61-72) have split across 80 MHz frequency subblocks. But the dynamic split of the unpunctured cases into the RU and MRU combination of (RU996, MRU3x996) (e.g., corresponding to field value 25-28) and the dynamic split of the 40 MHz puncturing cases into the RU and MRU combination of (RU484, MRU3x996) (e.g., corresponding to field value 41-48) and into RU and MRU combination of (RU996, MRU2x996+484) (e.g., corresponding to field value 49-60) does not have split across 80 MHz frequency subblocks.

Additionally or alternatively, if dynamic split supports 4 RU and MRU combinations of (RU996, MRU3x996) for the unpunctured case, 8 RU and MRU combinations of (RU484, MRU3x996) and 12 RU and MRU combinations of (RU996, MRU2x996+484) for the 40 MHz puncturing case, then the punctured channel information subfield may indicate an additional 24 entries (e.g., corresponding to field value 25-28, 41-60). That is, six bits in the punctured channel information subfield may be used for operations in accordance with the selected entries corresponding to field values of 0-28 and 41-60 in Tables 8, 9, 10, 11, and 12. Note that the dynamic split of the unpunctured cases into the RU and MRU combination of (RU996, MRU3x996) (e.g., corresponding to field value 25-28) and the dynamic split of the 40 MHz puncturing cases into the RU and MRU combination of (RU484, MRU3x996) (e.g., corresponding to field value 41-48) and into RU and MRU combination of (RU996, MRU2×996+484) (e.g., corresponding to field value 49-60) does not have split across 80 MHz frequency subblocks.

The RU and MRU definitions and notations in Tables 6-12 are in accordance with the definitions and notations in the IEEE 802.11be specification. In some examples, Table 1 through Table 12 may be configured at a wireless device receiving the MCS configuration message 225 (e.g., an STA 104). As such, based on the type of RU combination (e.g., interposed or non-interposed) and the type of PSDU configuration (e.g., single-PSDU or multi-PSDU), the wireless device receiving MCS configuration message 225 may use the associated Table to interpret the RU combination field and determine the RU combination to use for the communication multi-RU transmissions.

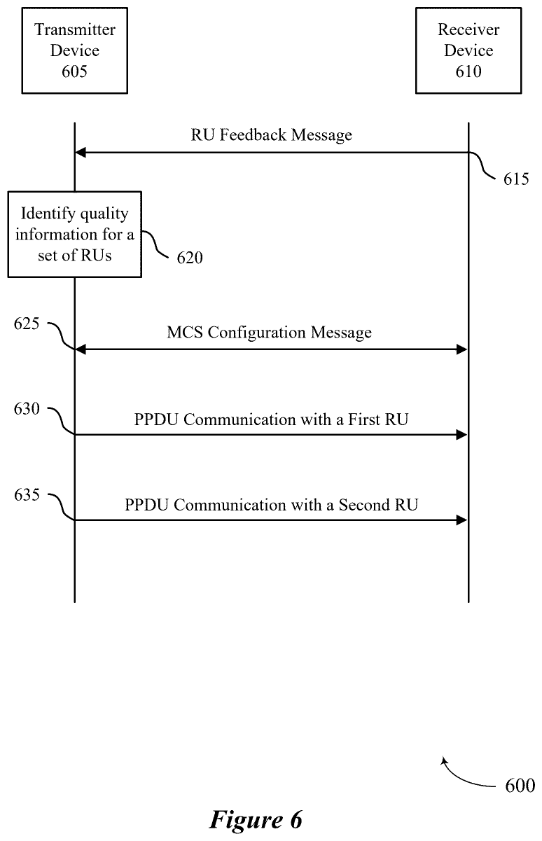

FIG. 6 shows an example of a process flow 600 that supports signaling support for multiple coding schemes to a single user device spanning a frequency domain. In some examples, process flow 600 may implement aspects of wireless communication network 100, signaling diagram 200, single PSDU encoding procedure 300 and 400, and multi-RU configuration design 500-a and 500-b. Process flow 600 includes a transmitter device 605 and a receiver device 610, which may be respective examples of a transmitter device 205 and a receiver device 210, as described with reference to FIGS. 2 through 5. Alternative examples of the following may be implemented, where some steps are performed in a different order than described or are not performed at all. In some cases, steps may include additional features not mentioned below, or further steps may be added. In addition, while process flow 600 shows processes between two devices, it should be understood that these processes may occur between any quantity of wireless devices and wireless device types.

At 615, the transmitter device 605 may optionally receive from the receiver device 610 a feedback message. For example, the feedback message my indicate respective feedback information associated with each RU of a set of RUs that span the frequency bandwidth. In some examples, the receiver device 610 may transmit the feedback message in cases where the receiver device 610 is an STA 104 and the transmitter device 605 is an AP 102. That is, in cases where the transmitter device 605 is an AP 102 transmitting one or more PPDUs (or a non-AP STA 104 in cases of point-to-point transmissions), the receiver device 610 (e.g., an STA 104) may transmit the feedback message indicating feedback information associated with each RU of the set of RUs. In some examples, each respective feedback information indicates, for an associated RU of the set of RUs, one or more of an interference metric, a suggested MCS, a suggested modulation pattern, a respective RU based bit error or packet error metric, or any combination thereof.

At 620, the transmitter device 605 may identify respective quality information associated with each RU of a set of RUs that span a frequency bandwidth. In a first example, where the transmitter device 605 is an AP 102 and the receiver is an STA 104, the transmitter device 605 may identify respective quality information from the respective feedback information included in the feedback message at 110. In a second example, where the transmitter device 605 is an STA 104 and the receiver device 610 is an AP 102, then the AP 102 may determine the quality information associated with each RU based on previous PPDUs from the STA 104.

At 625, the transmitter device 605 may transmit, in accordance with the respective quality information, information signaling that indicates a first MCS, a first modulation pattern, or both, to be applied to a first RU of the set of RUs and a second MCS, a second modulation pattern, or both, to be applied to a second RU. In some examples, the first MCS may differ from the second MCS and the first modulation pattern may differ from the second modulation pattern. In some examples, the frequency bandwidth may satisfy a bandwidth threshold, and the first RU and the second RU may each satisfy an RU size threshold.

In some examples, the first RU spans a first set of frequency carriers of the frequency bandwidth and a second set of frequency carriers of the frequency bandwidth and the second RU spans at least a third set of frequency carriers that is at a higher frequency than the first set of frequency carriers and a lower frequency than the second set of frequency carriers. That is, the second RU may be interposed within the frequency carriers of the first RU.

In some examples, the first RU spans a first set of frequency carriers of the frequency bandwidth, and the second RU spans a second set of frequency carriers that is lower in frequency than the first set of frequency carriers or higher in frequency than the first set of frequency carriers. That is, the first RU and the second RU are non-interposed in frequency.

In some examples of UHR MU PPDU communications, the information signaling may include one or more fields of information. For example, the information signaling may include a link type indicator that indicates whether the information signaling is associated with a configuration for UHR MU PPDU communications. Additionally, or alternatively, the information signaling may include a first field including a data unit type indicator that indicates whether the communications are for a single service data unit or multiple service data units a compression mode indicator that indicates a compression mode of the first wireless device. Additionally, or alternatively, the information signaling may include a puncture channel information subfield that indicates support for RU puncturing. Additionally, or alternatively, the information signaling may include a user field that indicates the first MCS, the first modulation pattern, or both to be applied to the first RU based on the first RU being an anchor RU. Additionally, or alternatively, the information signaling may include one or more fields indicating a relationship of the second RU relative to the first RU, where the one or more fields indicating the relationship are included in an UHR-SIG common field of the information signaling.

In some examples, the one or more fields indicating the relationship of the second RU relative to the first RU include one or more of an RU combination field that indicates respective frequency carriers associated with the first RU and the second RU, an MCS pattern field that indicates an MCS offset, where the second MCS applied to the second RU is equal to the MCS offset relative to the first MCS, or a modulation pattern field that indicates a modulation pattern offset, where the second modulation pattern applied to the second RU is equal to the modulation pattern offset relative to the first modulation pattern.

In some examples of UHR MU PPDU communications, information signaling may include a first user field and a second user field, where a first station identification in the first user field is a same station identification as a second station identification in the second user field. Additionally, or alternatively, the information signaling may include a first user field associated with the first RU that indicates the first MCS, the first modulation pattern, or both. Additionally, or alternatively, the information signaling may include a second user field associated with the second RU that indicates the second MCS, the second modulation pattern, or both.

At 630, the transmitter device 605 and receiver device 610 may communicate first data. For example, the transmitter device 605 and receiver device 610 may communicate in accordance with the information signaling, one or more first bits of a first service data unit via the first RU using the first MCS, the first modulation pattern, or both.

At 635, the transmitter device 605 and receiver device 610 may communicate second data. For example, the transmitter device 605 and receiver device 610 may communicate in accordance with the information signaling, one or more second bits of the first service data unit or of a second service data unit, via the second RU using the second MCS, the second modulation pattern, or both.

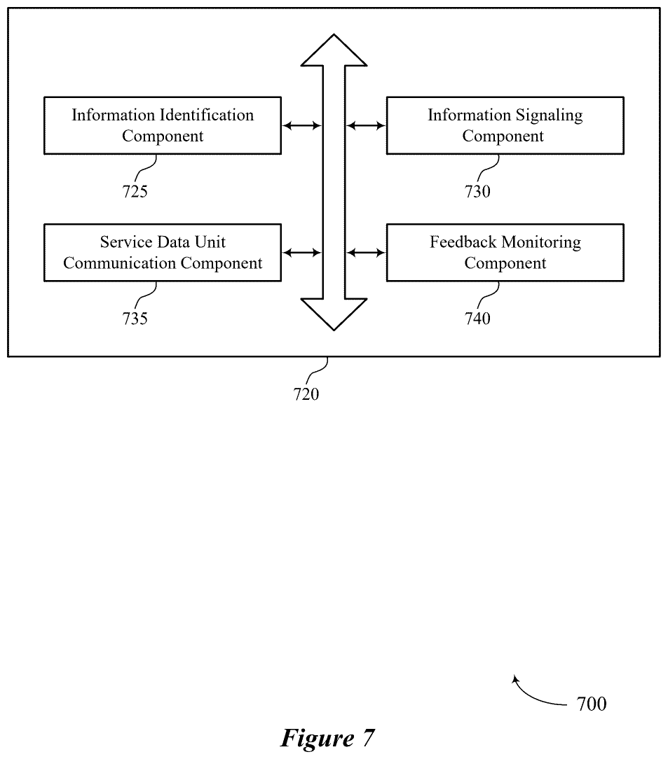

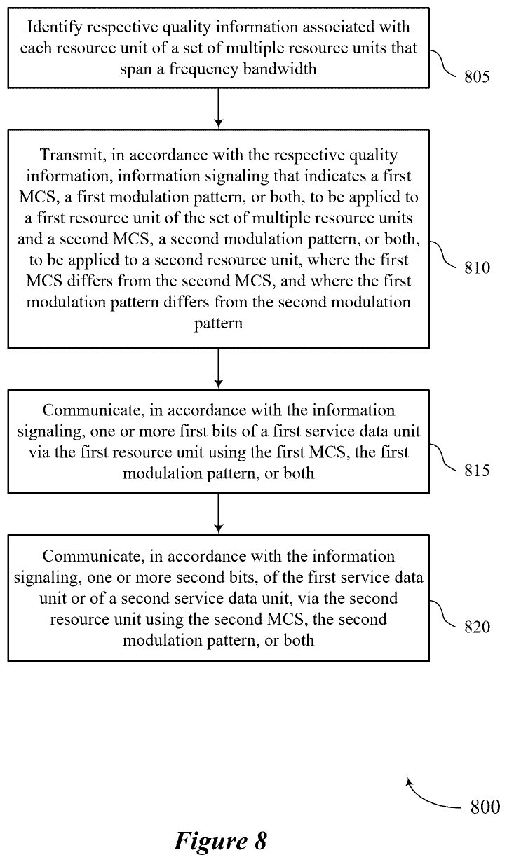

FIG. 7 shows a block diagram of an example wireless communication device 700 that supports signaling support for multiple coding schemes to a single user device spanning a frequency domain. In some examples, the wireless communication device 700 is configured to perform the process 800 described with reference to FIG. 8. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes an information identification component 725, an information signaling component 730, a service data unit communication component 735, and a feedback monitoring component 740. Portions of one or more of the information identification component 725, the information signaling component 730, the service data unit communication component 735, and the feedback monitoring component 740 may be implemented at least in part in hardware or firmware. For example, one or more of the information identification component 725, the information signaling component 730, the service data unit communication component 735, and the feedback monitoring component 740 may be implemented at least in part by at least a processor or a modem. In some examples, portions of one or more of the information identification component 725, the information signaling component 730, the service data unit communication component 735, and the feedback monitoring component 740 may be implemented at least in part by a processor and software in the form of processor-executable code stored in memory.

The wireless communication device 700 may support wireless communications in accordance with examples as disclosed herein. The information identification component 725 is configurable or configured to identify respective quality information associated with each RU of a set of multiple RUs that span a frequency bandwidth. The information signaling component 730 is configurable or configured to transmit, in accordance with the respective quality information, information signaling that indicates a first MCS, a first modulation pattern, or both, to be applied to a first RU of the set of multiple RUs and a second MCS, a second modulation pattern, or both, to be applied to a second RU, where the first MCS differs from the second MCS, and where the first modulation pattern differs from the second modulation pattern. The service data unit communication component 735 is configurable or configured to communicate, in accordance with the information signaling, one or more first bits of a first service data unit via the first RU using the first MCS, the first modulation pattern, or both. In some examples, the service data unit communication component 735 is configurable or configured to communicate, in accordance with the information signaling, one or more second bits, of the first service data unit or of a second service data unit, via the second RU using the second MCS, the second modulation pattern, or both.

In some examples, to support identifying the respective quality information, the feedback monitoring component 740 is configurable or configured to receive a feedback message indicating respective feedback information associated with each RU of the set of multiple RUs that span the frequency bandwidth, where the respective feedback information includes the respective quality information associated with each RU of the set of multiple RUs.

In some examples, each respective feedback information indicates, for an associated RU of the set of multiple RUs, one or more of an interference metric, a suggested MCS, a suggested modulation pattern, a respective RU based bit error or packet error metric, or any combination thereof.

In some examples, the frequency bandwidth satisfies a bandwidth threshold. In some examples, the first RU and the second RU each satisfy a RU size threshold.

In some examples, the first RU spans a first set of frequency carriers of the frequency bandwidth and a second set of frequency carriers of the frequency bandwidth. In some examples, the second RU spans at least a third set of frequency carriers that is at a higher frequency than the first set of frequency carriers and a lower frequency than the second set of frequency carriers.

In some examples, the first RU spans a first set of frequency carriers of the frequency bandwidth. In some examples, the second RU spans a second set of frequency carriers that is lower in frequency than the first set of frequency carriers or higher in frequency than the first set of frequency carriers.

In some examples, to support wireless communications, a communications manager 720 is configurable or configured to a link type indicator that indicate whether the information signaling is associated with a configuration for uplink communications or downlink communications, a first field including a data unit type indicator that indicates whether the communications are for a single service data unit or multiple service data units a compression mode indicator that indicates a compression mode of the first wireless device, a puncture channel information subfield that indicates support for RU puncturing, a user field that indicates the first MCS, the first modulation pattern, or both to be applied to the first RU based on the first RU being an anchor RU, or one or more fields indicating a relationship of the second RU relative to the first RU, where the one or more fields indicating the relationship are included in an UHR-SIG common field of the information signaling.

In some examples, a RU combination field that indicates respective frequency carriers associated with the first RU and the second RU, an MCS pattern field that indicates an MCS offset, where the second MCS applied to the second RU is equal to the MCS offset relative to the first MCS, or a modulation pattern field that indicates a modulation pattern offset, where the second modulation pattern applied to the second RU is equal to the modulation pattern offset relative to the first modulation pattern.

In some examples, to support information signaling, the communications manager 720 is configurable or configured to at least a first user field and a second user field, where a first station identification in the first user field be a same station identification as a second station identification in the second user field, a first user field associated with the first RU that indicates the first MCS, the first modulation pattern, or both, and a second user field associated with the second RU that indicates the second MCS, the second modulation pattern, or both.

FIG. 8 shows a flowchart illustrating an example process 800 performable by or at a first wireless device that supports signaling support for multiple coding schemes to a single user device spanning a frequency domain. The operations of the process 800 may be implemented by a first wireless device or its components as described herein. For example, the process 800 may be performed by a wireless communication device, such as the wireless communication device 700 described with reference to FIG. 7, operating as or within a wireless AP. In some examples, the process 800 may be performed by a wireless AP, such as one of the APs 102 described with reference to FIG. 1.

In some examples, in 805, the first wireless device may identify respective quality information associated with each RU of a set of multiple RUs that span a frequency bandwidth. The operations of 805 may be performed in accordance with examples as disclosed herein. In some implementations, aspects of the operations of 805 may be performed by an information identification component 725 as described with reference to FIG. 7.

In some examples, in 810, the first wireless device may transmit, in accordance with the respective quality information, information signaling that indicates a first MCS, a first modulation pattern, or both, to be applied to a first RU of the set of multiple RUs and a second MCS, a second modulation pattern, or both, to be applied to a second RU, where the first MCS differs from the second MCS, and where the first modulation pattern differs from the second modulation pattern. The operations of 810 may be performed in accordance with examples as disclosed herein. In some implementations, aspects of the operations of 810 may be performed by an information signaling component 730 as described with reference to FIG. 7.

In some examples, in 815, the first wireless device may communicate, in accordance with the information signaling, one or more first bits of a first service data unit via the first RU using the first MCS, the first modulation pattern, or both. The operations of 815 may be performed in accordance with examples as disclosed herein. In some implementations, aspects of the operations of 815 may be performed by a service data unit communication component 735 as described with reference to FIG. 7.

In some examples, in 820, the first wireless device may communicate, in accordance with the information signaling, one or more second bits, of the first service data unit or of a second service data unit, via the second RU using the second MCS, the second modulation pattern, or both. The operations of 820 may be performed in accordance with examples as disclosed herein. In some implementations, aspects of the operations of 820 may be performed by a service data unit communication component 735 as described with reference to FIG. 7.

Implementation examples are described in the following numbered clauses:

The following provides an overview of Clauses of the present disclosure:

Clause 1: A method for wireless communications, at a first wireless device, including: identifying respective quality information associated with each RU of a set of RUs that span a frequency bandwidth; transmitting, in accordance with the respective quality information, information signaling that indicates a first MCS, a first modulation pattern, or both, to be applied to a first RU of the set of RUs and a second MCS, a second modulation pattern, or both, to be applied to a second RU, wherein the first MCS differs from the second MCS, and wherein the first modulation pattern differs from the second modulation pattern; communicating, in accordance with the information signaling, one or more first bits of a first service data unit via the first RU using the first MCS, the first modulation pattern, or both; and communicating, in accordance with the information signaling, one or more second bits, of the first service data unit or of a second service data unit, via the second RU using the second MCS, the second modulation pattern, or both.

Clause 2: The method of Clause 1, wherein identifying the respective quality information includes: receiving a feedback message indicating respective feedback information associated with each RU of the set of RUs that span the frequency bandwidth, wherein the respective feedback information includes the respective quality information associated with each RU of the set of RUs.

Clause 3: The method of Clause 2, wherein each respective feedback information indicates, for an associated RU of the set of RUs, one or more of an interference metric, a suggested MCS, a suggested modulation pattern, a respective RU based bit error or packet error metric, or any combination thereof.

Clause 4: The method of any of Clauses 1 through 3, wherein the frequency bandwidth satisfies a bandwidth threshold, and the first RU and the second RU each satisfy a RU size threshold.

Clause 5: The method of any of Clauses 1 through 4, wherein the first RU spans a first set of frequency carriers of the frequency bandwidth and a second set of frequency carriers of the frequency bandwidth, and the second RU spans at least a third set of frequency carriers that is at a higher frequency than the first set of frequency carriers and a lower frequency than the second set of frequency carriers.

Clause 6: The method of any of Clauses 1 through 5, wherein the first RU spans a first set of frequency carriers of the frequency bandwidth, and the second RU spans a second set of frequency carriers that is lower in frequency than the first set of frequency carriers or higher in frequency than the first set of frequency carriers.

Clause 7: The method of any of Clauses 1 through 6, wherein the information signaling includes one or more of: a link type indicator that indicates whether the information signaling is associated with a configuration for uplink communications or downlink communications, a first field including a data unit type indicator that indicates whether communications are for a single service data unit or multiple service data units a compression mode indicator that indicates a compression mode of the first wireless device, a puncture channel information subfield that indicates support for RU puncturing, an anchor RU indication subfield that indicates an anchor RU, a user field that indicates the first MCS, the first modulation pattern, or both to be applied to the first RU based at least in part on the first RU being the anchor RU, or one or more fields indicating a relationship of the second RU relative to the first RU, wherein the one or more fields indicating the relationship are included in an UHR-SIG common field of the information signaling.

Clause 8: The method of Clause 7, wherein the one or more fields indicating the relationship of the second RU relative to the first RU include one or more of a RU combination field that indicates respective frequency carriers associated with the first RU and the second RU, an MCS pattern field that indicates an MCS offset, wherein the second MCS applied to the second RU is equal to the MCS offset relative to the first MCS, or a modulation pattern field that indicates a modulation pattern offset, wherein the second modulation pattern applied to the second RU is equal to the modulation pattern offset relative to the first modulation pattern.

Clause 9: The method of any of Clauses 1 through 8, wherein the information signaling includes at least a first user field and a second user field, a first station identification in the first user field is a same station identification as a second station identification in the second user field, the first user field associated with the first RU that indicates the first MCS, the first modulation pattern, or both, and the second user field associated with the second RU that indicates the second MCS, the second modulation pattern, or both.

Clause 10: A first wireless device for wireless communications, including one or more memories storing processor-executable code, and one or more processors coupled with the one or more memories and individually or collectively operable to execute the code to cause the first wireless device to perform a method of any of Clauses 1 through 9.

Clause 11: A first wireless device for wireless communications, including at least one means for performing a method of any of Clauses 1 through 9.

Clause 12: A non-transitory computer-readable medium storing code for wireless communications, the code including instructions executable by one or more processors to perform a method of any of Clauses 1 through 9.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described herein as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described herein should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
identify respective quality information associated with each resource unit of a plurality of resource units that span a frequency bandwidth;
transmit, in accordance with the respective quality information, information signaling that indicates a first modulation and coding scheme (MCS), a first modulation pattern, or both, to be applied to a first resource unit of the plurality of resource units and a second MCS, a second modulation pattern, or both, to be applied to a second resource unit, wherein the first MCS differs from the second MCS, and wherein the first modulation pattern differs from the second modulation pattern;
communicate, in accordance with the information signaling, one or more first bits of a first service data unit via the first resource unit using the first MCS, the first modulation pattern, or both; and
communicate, in accordance with the information signaling, one or more second bits, of the first service data unit or of a second service data unit, via the second resource unit using the second MCS, the second modulation pattern, or both.

2. The first wireless device of claim 1, wherein, to identify the respective quality information, the processing system is configured to cause the first wireless device to:
receive a feedback message indicating respective feedback information associated with each resource unit of the plurality of resource units that span the frequency bandwidth, wherein the respective feedback information comprises the respective quality information associated with each resource unit of the plurality of resource units.

3. The first wireless device of claim 2, wherein each respective feedback information indicates, for an associated resource unit of the plurality of resource units, one or more of an interference metric, a suggested MCS, a suggested modulation pattern, a respective resource unit based bit error or packet error metric, or any combination thereof.

4. The first wireless device of claim 1, wherein:
the frequency bandwidth satisfies a bandwidth threshold; and
the first resource unit and the second resource unit each satisfy a resource unit size threshold.

5. The first wireless device of claim 1, wherein:
the first resource unit spans a first set of frequency carriers of the frequency bandwidth and a second set of frequency carriers of the frequency bandwidth; and
the second resource unit spans at least a third set of frequency carriers that is at a higher frequency than the first set of frequency carriers and a lower frequency than the second set of frequency carriers.

6. The first wireless device of claim 1, wherein:
the first resource unit spans a first set of frequency carriers of the frequency bandwidth; and
the second resource unit spans a second set of frequency carriers that is lower in frequency than the first set of frequency carriers or higher in frequency than the first set of frequency carriers.

7. The first wireless device of claim 1, wherein the information signaling comprises one or more of:
a link type indicator that indicate whether the information signaling is associated with a configuration for uplink communications or downlink communications;
a first field comprising a data unit type indicator that indicates whether communications are for a single service data unit or multiple service data units a compression mode indicator that indicates a compression mode of the first wireless device;
a puncture channel information subfield that indicates support for resource unit puncturing;
an anchor resource unit indication subfield that indicates an anchor resource unit;
a user field that indicates the first MCS, the first modulation pattern, or both to be applied to the first resource unit based at least in part on the first resource unit being the anchor resource unit; or
one or more fields indicating a relationship of the second resource unit relative to the first resource unit, wherein the one or more fields indicating the relationship are comprised in an ultra high reliability signature common field of the information signaling.

8. The first wireless device of claim 7, wherein the one or more fields indicating the relationship of the second resource unit relative to the first resource unit comprise one or more of:
a resource unit combination field that indicates respective frequency carriers associated with the first resource unit and the second resource unit;
an MCS pattern field that indicates an MCS offset, wherein the second MCS applied to the second resource unit is equal to the MCS offset relative to the first MCS; or
a modulation pattern field that indicates a modulation pattern offset, wherein the second modulation pattern applied to the second resource unit is equal to the modulation pattern offset relative to the first modulation pattern.

9. The first wireless device of claim 1, wherein the information signaling comprises:
at least a first user field and a second user field, wherein a first station identification in the first user field be a same station identification as a second station identification in the second user field;
the first user field associated with the first resource unit that indicates the first MCS, the first modulation pattern, or both; and
the second user field associated with the second resource unit that indicates the second MCS, the second modulation pattern, or both.

10. A method for wireless communications, at a first wireless device, comprising:
identifying respective quality information associated with each resource unit of a plurality of resource units that span a frequency bandwidth;
transmitting, in accordance with the respective quality information, information signaling that indicates a first modulation and coding scheme (MCS), a first modulation pattern, or both, to be applied to a first resource unit of the plurality of resource units and a second MCS, a second modulation pattern, or both, to be applied to a second resource unit, wherein the first MCS differs from the second MCS, and wherein the first modulation pattern differs from the second modulation pattern;
communicating, in accordance with the information signaling, one or more first bits of a first service data unit via the first resource unit using the first MCS, the first modulation pattern, or both; and
communicating, in accordance with the information signaling, one or more second bits, of the first service data unit or of a second service data unit, via the second resource unit using the second MCS, the second modulation pattern, or both.

11. The method of claim 10, wherein identifying the respective quality information comprises:
receiving a feedback message indicating respective feedback information associated with each resource unit of the plurality of resource units that span the frequency bandwidth, wherein the respective feedback information comprises the respective quality information associated with each resource unit of the plurality of resource units.

12. The method of claim 11, wherein each respective feedback information indicates, for an associated resource unit of the plurality of resource units, one or more of an interference metric, a suggested MCS, a suggested modulation pattern, a respective resource unit based bit error or packet error metric, or any combination thereof.

13. The method of claim 10, wherein:
the frequency bandwidth satisfies a bandwidth threshold; and
the first resource unit and the second resource unit each satisfy a resource unit size threshold.

14. The method of claim 10, wherein:
the first resource unit spans a first set of frequency carriers of the frequency bandwidth and a second set of frequency carriers of the frequency bandwidth; and
the second resource unit spans at least a third set of frequency carriers that is at a higher frequency than the first set of frequency carriers and a lower frequency than the second set of frequency carriers.

15. The method of claim 10, wherein:
the first resource unit spans a first set of frequency carriers of the frequency bandwidth; and
the second resource unit spans a second set of frequency carriers that is lower in frequency than the first set of frequency carriers or higher in frequency than the first set of frequency carriers.

16. The method of claim 10, wherein the information signaling comprises one or more of:
a link type indicator that indicates whether the information signaling is associated with a configuration for uplink communications or downlink communications;
a first field comprising a data unit type indicator that indicates whether communications are for a single service data unit or multiple service data units a compression mode indicator that indicates a compression mode of the first wireless device;
a puncture channel information subfield that indicates support for resource unit puncturing;
an anchor resource unit indication subfield that indicates an anchor resource unit;
a user field that indicates the first MCS, the first modulation pattern, or both to be applied to the first resource unit based at least in part on the first resource unit being the anchor resource unit; or
one or more fields indicating a relationship of the second resource unit relative to the first resource unit, wherein the one or more fields indicating the relationship are comprised in an ultra high reliability signature common field of the information signaling.

17. The method of claim 16, wherein the one or more fields indicating the relationship of the second resource unit relative to the first resource unit comprise one or more of:
a resource unit combination field that indicates respective frequency carriers associated with the first resource unit and the second resource unit;
an MCS pattern field that indicates an MCS offset, wherein the second MCS applied to the second resource unit is equal to the MCS offset relative to the first MCS; or
a modulation pattern field that indicates a modulation pattern offset, wherein the second modulation pattern applied to the second resource unit is equal to the modulation pattern offset relative to the first modulation pattern.

18. The method of claim 10, wherein the information signaling comprises:
at least a first user field and a second user field, wherein a first station identification in the first user field is a same station identification as a second station identification in the second user field;
the first user field associated with the first resource unit that indicates the first MCS, the first modulation pattern, or both; and
the second user field associated with the second resource unit that indicates the second MCS, the second modulation pattern, or both.

19. A non-transitory computer-readable medium storing code for wireless communications, the code comprising instructions executable by one or more processors to:
identify respective quality information associated with each resource unit of a plurality of resource units that span a frequency bandwidth;
transmit, in accordance with the respective quality information, information signaling that indicates a first modulation and coding scheme (MCS), a first modulation pattern, or both, to be applied to a first resource unit of the plurality of resource units and a second MCS, a second modulation pattern, or both, to be applied to a second resource unit, wherein the first MCS differs from the second MCS, and wherein the first modulation pattern differs from the second modulation pattern;
communicate, in accordance with the information signaling, one or more first bits of a first service data unit via the first resource unit using the first MCS, the first modulation pattern, or both; and
communicate, in accordance with the information signaling, one or more second bits, of the first service data unit or of a second service data unit, via the second resource unit using the second MCS, the second modulation pattern, or both.

20. The non-transitory computer-readable medium of claim 19, wherein the instructions to identify the respective quality information are executable by the one or more processors to:
receive a feedback message indicating respective feedback information associated with each resource unit of the plurality of resource units that span the frequency bandwidth, wherein the respective feedback information comprises the respective quality information associated with each resource unit of the plurality of resource units.
